(19) United States
(12) Patent Application Publication
(10) Pub. No.: US 2006/0067341 A1
(43) Pub. Date: Mar. 30, 2006

(54) Method, system and computer program using standard interfaces for independent device controllers

(76) Inventors: Ronald W. Barber, Plano, TX (US); Joel S. Dick, Garland, TX (US); Robert C. Hicks, Allen, TX (US); Larry A. Huebel, Trophy Club, TX (US); James R. Shillington, Wylie, TX (US); Marjorie L. Smith, Garland, TX (US); Mark E. Smith, Garland, TX (US); Michael J. Strong, Wylie, TX (US); Robert D. Ward, Bellevue, WA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/222,885

(22) Filed: Sep. 9, 2005

Related U.S. Application Data
(60) Provisional application No. 60/608,439, filed on Sep. 9, 2004.

(51) Int. Cl. H04L 12/56

(52) U.S. Cl. 370/401; 370/465

(57) ABSTRACT

A system, method and computer program for controlling devices in a control area network that includes providing a first application programming interface containing a first set of functions in a control area network and coupling one or more functions of the first set of functions with a physical device. The control area network includes a master controller, one or more physical devices, and one or more physical communication interfaces. Coupling one or more functions of the first set of functions with a physical device. Each physical device is coupled using one or more of the physical device communication interfaces

### CROSS REFERENCE TO RELATED APPLICATIONS

The present document claims the benefit of the earlier filing date of co-pending U.S. provisional patent application Ser. No. 60/608,439, entitled “METHOD, SYSTEM AND COMPUTER PROGRAM USING STANDARD INTERFACES FOR INDEPENDENT DEVICE CONTROLLERS,” filed in the U.S. Patent and Trademark Office on Sep. 9, 2004, and having common inventors as the present document, the entire contents of which is incorporated herein by reference.

### BACKGROUND OF THE INVENTION

1. Field of the Invention

The present invention relates to control systems and more particularly to a system, method and computer program using a standard framework of classes and interfaces to interface with independent device controllers and independent devices.

2. Discussion of the Background

Through the use of a control system, various equipment or appliances in an environment, such as a home or business, can be computer-controlled to form an automated environment. The controlled equipment may include heating, ventilation and air conditioning (HVAC) systems, lighting systems, audio-visual systems, telecommunications systems, security systems, surveillance systems, and fire protection systems, for example. The equipment may be coupled to equipment controlling devices that are linked to a computer-based master controller through the use of a control area network. One or more user interface devices, such as a touch panel may also be linked to the control area network to accept user input and display current system status. Other inputs, such as temperature, optical rain sensors, and contact closures may also be linked to the control system. These other inputs may be coupled to input sensing devices that are linked to a computer based master controller through the use of a control area network.

Traditional control systems typically have provided limited or no capability for a standard framework of classes to interface with independent device controllers.

### SUMMARY OF THE INVENTION

Accordingly, one aspect of the present invention is to provide a method for controlling devices in a control area network that includes providing a first application programming interface containing a first set of functions in a control area network and coupling one or more functions of the first set of functions with a physical device. The control area network includes a master controller, one or more physical devices, and one or more physical communication interfaces. Coupling one or more functions of the first set of functions with a physical device. Each physical device is coupled using one or more of the physical device communication interfaces.

Another aspect of the present invention is to provide a computer program for controlling devices in a control area network that includes a first computer code for providing a first application programming interface containing a first set of functions in a control area network and a second computer code for coupling one or more functions of the first set of functions with a physical device. The control area network includes a master controller, one or more physical devices, and one or more physical communication interfaces. Coupling one or more functions of the first set of functions with a physical device. Each physical device is coupled using one or more of the physical device communication interfaces.

Another aspect of the present invention is to provide a computer system for controlling devices in a control area network that includes one or more processors and a computer readable medium connected to the processors, the computer readable medium including processor instructions configured to be read by the processors and thereby cause the processors to provide a first application programming interface containing a first set of functions in a control area network and couple one or more functions of the first set of functions with a physical device. The control area network includes a master controller, one or more physical devices, and one or more physical communication interfaces. Each physical device is coupled using one or more of the physical device communication interfaces.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a simplified top-level block diagram of a control system configuration according to an embodiment of the present invention;

FIG. 2 is a block diagram illustrating the components of a master controller according to an embodiment of the present invention;

FIG. 3 is a block diagram illustrating a standard interface device controller configuration according to an embodiment of the present invention;

FIG. 4 is a block diagram illustrating another standard interface device controller configuration according to an embodiment of the present invention;

FIG. 5 is a flow chart illustrating command processing using a standard interface device controller according to an embodiment of the present invention; and

FIG. 6 is a block diagram illustrating a control system configuration interconnecting two disparate protocols according to an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

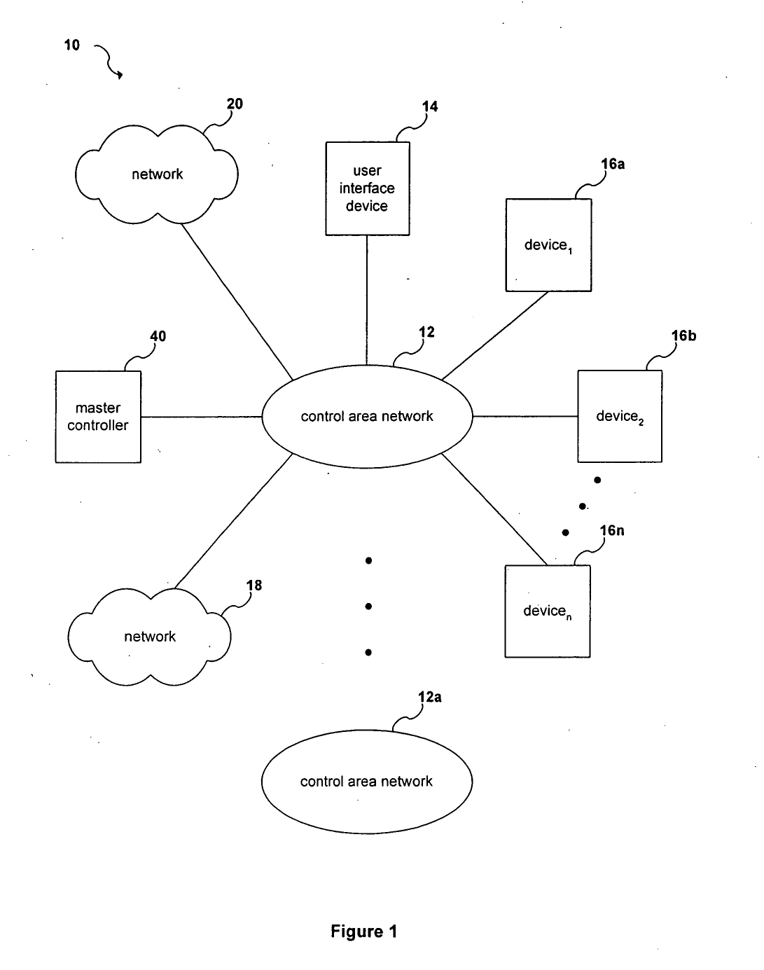

Referring to FIG. 1, a simplified top-level block diagram of a control system 10 configuration according to an embodiment of the present invention is shown. One or more devices 16a-16n in the control system 10 can send control commands to and/or receive control messages from a master controller 40 on one or more control area networks 12 and 12a. The present invention includes common application programming interfaces (APIs) that are used to represent the one or more devices 16a-16n. The one or more devices 16a-16n may be wholly unrelated in technology. Therefore, the common APIs represent the one or more devices 16a-16n by defining a structure whereby different device technologies are grouped together into classes by common operation and/or functionality from the general to the specific. Thus, different classes are used to represent different groups and subgroups of technology for the one or more devices 16a-16n. For instance, a class may represent all home entertainment devices, such as VCR, television, CD and DVD. Another class may represent specifically all brands of VCRs and another class may represent a particular brand/vendor of the VCR. The present invention recognizes that event devices that are wholly unrelated in technology may share common functionality. For instance, a DVD, TIVO, VCR, LD and Cassette Deck each share the functional ability of playing some form of media. Thus, common APIs are used to abstract the operational and/or functional capabilities of the one or more devices 16a-16n, such that applications may communicate with the one or more devices 16a-16n without concern for the underlying technology and/or proprietary protocols of the devices.

Control system 10 includes one or more control area networks (CAN) 12 and 12a. Control area networks 12 and 12a are local area networks used to interconnect a variety of devices 16a-16n, user interface device 14 and master controller 40. Optionally, the control area network may be used to interconnect other networks 18 and 20, such as a proprietary network, local area network, an Intranet, or the Internet. Control area networks 12 and 12a may be used to interconnect multiple disparate protocols. For instance, a Microsoft UPnP (Universal Plug and Play) network may be interconnected to a Sun Microsystems JINI network via control area networks 12 and 12a. Devices 16a-16n include, but are not limited to, physical and logical devices, equipment, and appliances. The underlying network may be wired, wireless, power line carriers, or any suitable transmission medium. Some devices may be coupled to control area networks 12 and 12a via additional intermediate communications devices such as an RS 232 controller (not shown).

User interface device 14 is any device that is capable of receiving user input and displaying or indicating control network status. For example, a touch panel, a computer terminal with a monitor, keyboard and pointing device, and any device with similar functionalities may serve as user interface device 14. In addition, a user interface is any device that is capable of receiving user input such as a simple push button keypad, which may not have indicators for feedback, or an Infra-red remote control.

Master controller 40 generally includes a CPU-based controller that controls the communications among user interface device 14 and devices 16a-16n. It is operable to receive user inputs received by user interface devices, such as commands, and instruct the appropriate device 16a-16n to act according to the command. Master controller 40 may also poll each device in control area network 12 periodically to monitor its status. The system status and/or the status of each device may be sent to user interface device 14 for display.

Devices 16a-16n are configured to receive commands from master controller 40 and operate or act according to the command. Devices 16a-16n may include equipment that affect or monitor the various parameters of the premises. For example, devices 16a-16n may include heating and air conditioning, lighting, video equipment, audio equipment, sprinklers, security cameras, infrared sensors, smoke detectors, or other similar device in a residential or commercial control area network 12. Devices 16a-16n may also be household appliances, such as a hot tub, fireplace, microwave oven, coffee maker, or other similar device that are capable of providing a current status of its operational state to master controller 40, such as on/off, temperature settings, current ambient temperature, light intensity settings, volume settings, threshold settings, and predetermined alphanumeric strings reflective of operational states. Further, devices 16a-16n may represent a logical device, such as another control system 10 or a virtual device representing multiple physical devices.

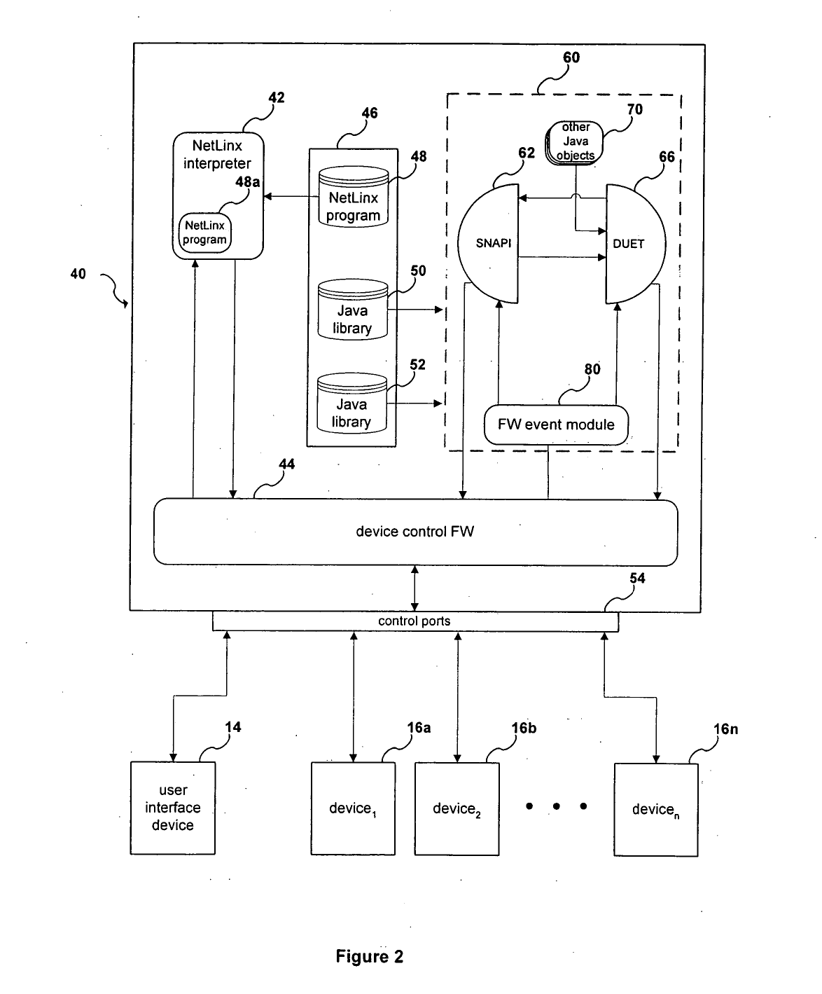

Referring to FIG. 2, a block diagram illustrating the components of a master controller 40 according to an embodiment of the present invention is shown. Master controller 40 includes, but is not limited to, device control firmware 44, a NetLinx interpreter 42 executing a NetLinx program 48a, memory area 46, one or more control ports 54 and a Java virtual machine 60. One or more devices 16a-16n and user interface device 14 are connected to master controller via control ports 54, or other input means (not shown). Memory Area 46 includes a NetLinx program 48 that is executed as NetLinx program 48a by NetLinx interpreter 42, and one or more Java libraries 50 and 52 that are used by the Java virtual machine 60. The one or more Java libraries 50 and 52 may be dynamically loaded and/or updated with new methods while the Java virtual machine 60 is executing. The Java libraries 50 and 52 may be either a standard Java Archive (JAR) file or an Open Service Gateway Initiative (OSGi) bundle. An OSGi bundle is a JAR (jar) file with a manifest file (.mf) listing the services that are exported by the bundle (via a package name) as well as any service that the bundle itself requires for execution. Within the OSGi framework every bundle has a pre-defined lifecycle.

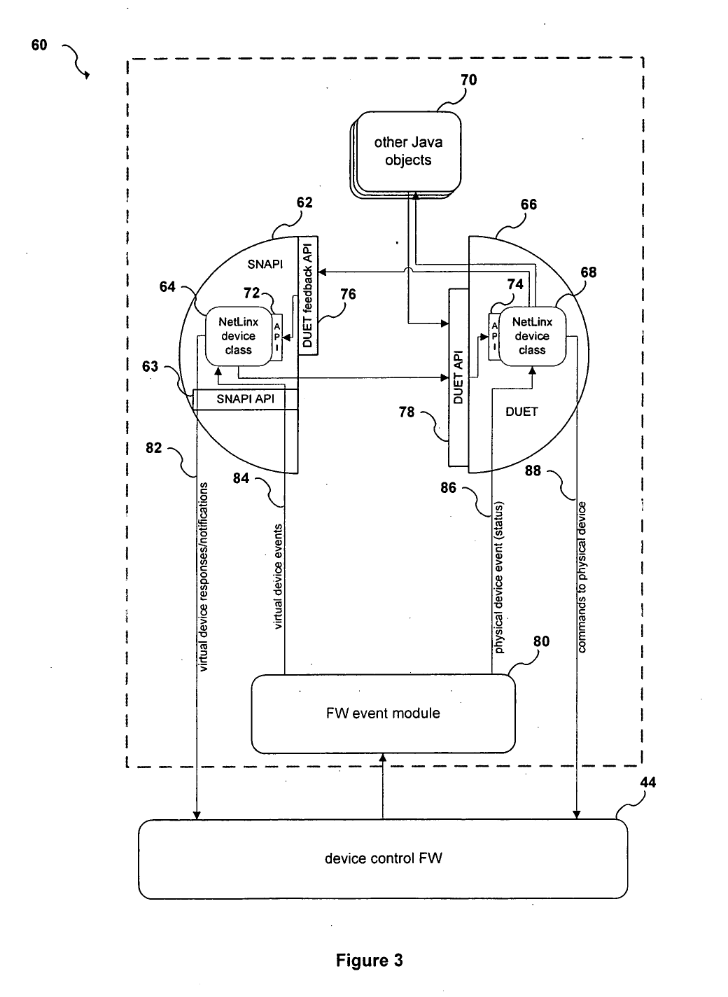

Referring to FIG. 3, a block diagram illustrating a standard interface device controller configuration according to an embodiment of the present invention is shown. The Java virtual machine 60 includes a firmware event module 80, a router (SNAPI) object 62, DUET object 66, and optionally one or more other Java objects 70.

Generally, the DUET object 66 provides services to translate between a set of device specific API calls and a device's proprietary protocol, thereby hiding the proprietary protocol from the service user. For example, a DUET object 66 that is communicating with a VCR that uses a proprietary serial protocol might provide PLAY, STOP, PAUSE, FFW and REWIND services via the DUET API 78. The DUET object 66 generates the necessary serial protocol data and communicates with the VCR. Any object having access to the DUET object 66 could invoke a DUET API 78 method to affect change on the physical VCR with no knowledge of the underlying protocol.

The DUET object 66 contains a majority of the translation between a standard API and the proprietary protocol of the one or more devices 16a-16n. For instance, the DUET object 66 contains a majority of the translation between the standard API and the proprietary protocol for a manufacturer's brand of a particular physical device. The DUET object 66 may include one or more NetLinx device class 68 objects each having a NetLinx API 74, and a standard DUET API 78 grouped into device categories. The DUET API 78 device categories include, but are not limited to, a switcher, an A/V receiver, a plasma monitor, a video projector, a television, a digital satellite system (DSS), a set top box, a disk device, a DVR/PVR, a digital media player, a VCR, a video conferencer, an audio conferencer, an audio tuner, a cassette deck, a level controller, a pre-amplifier, a audio processor, a camera, a document camera, a slide projector, lights, an HVAC, a security system, a weather device, a pool or spa, and a lift/screen/shade/window/door. Each DUET API 78 device category includes a standard API that is specific to that device category. For instance, the DUET API 78 may include play( ), stop( ), pause( ), ffw( ) and rewind( ) methods that correspond to VCR devices.

The DUET object 66 communicates with both the SNAPI object 62, the FW event module 80 and, optionally, one or more other Java objects 70. The DUET object 66 implements a standard DUET API 78. The SNAPI object 62 communicates with the DUET object 66 by invoking methods specific to device categories in the standard DUET API 78 of the DUET object 66. One or more NetLinx device class 68 objects will then execute the necessary device specific processing for a specific task. The NetLinx device class 68 encapsulates the communication protocols necessary to communicate with a specific device or equipment controlling device (e.g., a single D:P:S). The NetLinx device class 68 API includes, but is not limited to, on( ), off( ), send_level( ) and send_string( ) methods. For example, a play( ) method on an IR controlled VCR would request the underlying physical device (IR emitter) to send IR pulses to a VCR, thereby resulting in a play operation on the VCR. However, not all DUET objects 66 will have a NetLinx device class 68. Access to one or more devices 16a-16n may also be through some other Java enabled transport (e.g, TCP/IP sockets), instead of a NetLinx device class 68.

The one or more devices 16a-16n indirectly communicate with the DUET object 66 using event handlers. In particular, the one or more devices 16a-16n communicate with the device control firmware 44, the device control firmware 44 routes any communication to the FW event module 80, and the FW event module 80 posts events to pass this communication to a NetLinx device class 68 of the DUET object 66. The DUET NetLinx device class 68 includes, but is not limited to, a IChannelListener interface, a IButtonListener interface, a ILevelListener interface, a IDataListener interface and a ICustomListener interface, each having one or more corresponding event handler methods to catch the event posted by the FW event module 80. The IButtonListener handles button push and release events. The IChannelListener handles channel on and off events. The ILevelListener handles level events. The IDataListener handles string, command, online and offline events. The ICustomListener is a catch-all for all other types of events. A DUET NetLinx device class 68 only implements those interfaces that it needs. The DUET object 66 processes device events by translating proprietary event data into a status object that is understood by the SNAPI object 62 along with any other entity, other Java objects 70, listening for events from one or more devices 16a-16n. Entities that wish to receive device events register as a listener with the DUET object 66. When an event occurs, the event data is packaged into a status object and a predefined handler routine is called for each of the registered listeners.

A DUET object 66 does not necessarily have its own processing thread. For instance, a DUET object 66 utilizing a NetLinx device class 68 object as its connect to one or more devices 16a-16n will most likely not have its own thread. Instead, its ‘receive’ thread is provided by an underlying event router thread that is receiving data from the firmware event module 80. Whereas, a DUET object that communicates with one or more devices 16a-16n via a TCP/IP socket must provide a separate thread of execution as a listener to the TCP/IP socket.

A router is the inverse of a DUET object 66. A SNAPI object 62 processes data coming into the JVM in a proprietary format and translates it into calls made into a DUET object 66. The SNAPI object 62 is configured to indirectly communicate with a NetLinx program 48a. The router (SNAPI) object 62 may include one or more NetLinx device class 64 objects each having a NetLinx API 72, and a standard DUET feedback API 76. The SNAPI object 62 communicates with both the DUET object 66 and the FW event module 80. The NetLinx program 48a indirectly communicates with the SNAPI object 62 using event handlers. In particular, the NetLinx program 48a communicates with the device control firmware 44, the device control firmware 44 routes any communication to the FW event module 80, and the FW event module 80 posts events to pass this communication to a NetLinx device class 64 of the SNAPI object 62. Similar to the DUET NetLinx device class 68, the SNAPI NetLinx device class 64 includes, but is not limited to, a IChannelListener interface, a IButtonListener interface, a ILevelListener interface, a IDataListener interface and a ICustomListener interface, each having one or more corresponding event handler methods to catch the event thrown by the FW event module 80.

Optionally, a DUET object 66 may expose multiple DUET APIs 78 in order to represent a device 16a-16n having combination functionality. For example, if a DUET object 66 controls a combination VCR/DVD player device 16a, the DUET object 66 could expose a VCR DUET API 78 and a DVD DUET API 78. Thereby, Java objects 70 would have access to the VCR functionality of the combination VCR/DVD player device 16a by invoking methods in the VCR DUET API 78 and access to the DVD functionality of the combination VCR/DVD player device 16a through the DVD DUET API 78.

Optionally, a single DUET object 66 may also serve as a controller for multiple physical devices 16a-16n, thereby creating a new abstract device. For example, a DUET object 66 could represent a matrix or library of VCR devices 16a-16n by having multiple NetLinx device class objects 68, each controlling a different physical VCR device 16a-16n.

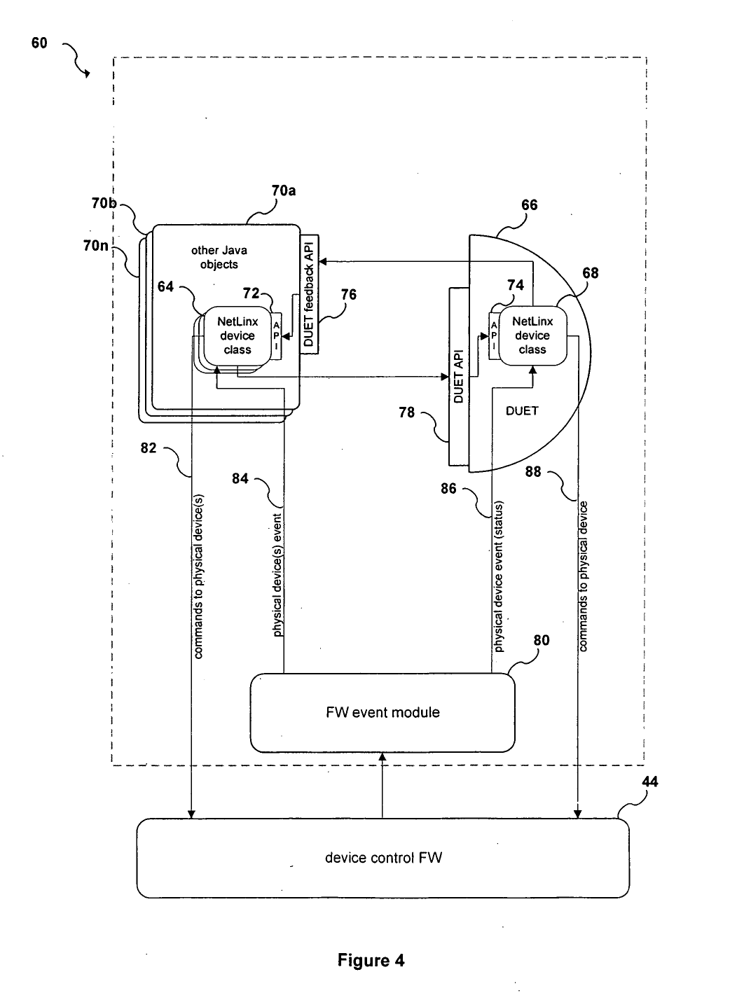

Referring to FIG. 4, a block diagram illustrating another standard interface device controller configuration according to an embodiment of the present invention is shown. In this embodiment, one or more of the other Java objects 70 is a router object 70a that may include a NetLinx device class 64 having a NetLinx API 72. The router object 70a has similar functionality as the SNAPI object 62 previously described, but is configured to communicate directly with Java programs using Java methods.

As shown in FIGS. 3 and 4, multiple Java objects 70a-70n (FIG. 4) or 70 (FIG. 3) may communicate with a single DUET object 66 and its associated one or more devices 16a-16n by invoking methods in the standard DUET API 78 of the DUET object 66. For example, a Java object 70a that controls a touchpanel and a Java object 70b that controls a keypad may both communicate with a particular VCR device 16a which is controlled through a single DUET object 66. In this instance, both Java objects 70a and 70b could invoke DUET API 78 method(s) to affect changes on the physical VCR device 16a. Similarly, both Java objects 70a and 70b would be notified of changes on the VCR device 16a through their respective DUET feedback APIs 76.

The configuration as shown in FIG. 3 may be used to communicate with a NetLinx program 48a whereas the configuration as shown in FIG. 4 may be used to communicate with existing and future generations of Java enabled devices. Optionally, the configurations shown as in FIGS. 3 and 4 may co-exist simultaneously in the same control system 10, such that Java programs and NetLinx programs may co-exist within the same control system 10.

The IModuleStandard interface provides an API for assignment of real hardware devices and module virtual devices. The IModuleStandard API includes, but is not limited to, the following:
public void cancelTimer( )
public void dispose( )
public void formatDate(java.text.SimpleDateFormat dateFormat)
public void formatTime(java.text.SimpleDateFormat timeFormat)
public com.amx.duet.devicesdk.device.type.DebugState getDebugState( )
public java.util.Date getTime( )
public java.util.Date getTime(com.amx.duet.devicesdk.device.type.Zone zone)
public long getTimerDelay( )
public long getTimerPeriod( )
public java.lang.String getVersion( )
public boolean isDeviceCommunicatingOn( )
public boolean isEnableOn( )
public void passThru(byte[ ] buffer)
public void passThru(com.amx.duet.devicesdk.device.type.Zone zone, byte[ ] buffer)
public void reboot( )
public void reset( )
public void setDebugState(com.amx.duet.devicesdk.device.type.DebugState state)
public void setDeviceCommunicatingOn(boolean state)
public void setEnableOn(boolean state)
public void setTime(com.amx.duet.devicesdk.device.type.Zone zone, java.util.Date date)
public void setTime(java.util.Date date)
public void setTimerDelay(long delay)
public void setTimerPeriod(long period)
public void startTimer( )

The AudioConferencer class provides a standard API for communication with and control of audio conference devices. The AudioConferencer API includes, but is not limited to, the following methods:
public AudioConferencer( )
public AudioConferencer(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustTreble(com.amx.duet.devicesdk.device.type.Zone zone, int offset)
public void adjustVolume(com.amx.duet.devicesdk.device.type.Zone zone, int offset)
public void cycleAudibleRing(com.amx.duet.devicesdk.device.type.Controller ctrller)
public void cycleAutoAnswer(com.amx.duet.devicesdk.device.type.Controller ctrller)
public void cycleLoudness(com.amx.duet.devicesdk.device.type.Zone zone)
public void cycleOffHook(com.amx.duet.devicesdk.device.type.Controller ctrller)
public void cyclePower( )
public void cyclePrivacy( )
public void cycleSurroundMode(com.amx.duet.devicesdk.device.type.Zone zone)
public void cycleVolumeMute(com.amx.duet.devicesdk.device.type.Zone zone)
public void dialNumber(com.amx.duet.devicesdk.device.type.Controller ctrller, com.amx.duet.devicesdk.device.type.SpeedDialEntry pbe)
public void dialNumber(com.amx.duet.devicesdk.device.type.Controller ctrller, java.lang.String number)
public void finalize( )
public void flash(com.amx.duet.devicesdk.device.type.Controller ctrller)
public com.amx.duet.devicesdk.device.component.IDialerComponent getAudioDialer(int index)
public int getBalance(com.amx.duet.devicesdk.device.type.Zone zone)
public int getBass(com.amx.duet.devicesdk.device.type.Zone zone)
public java.lang.String getCallerID(com.amx.duet.devicesdk.device.type.Controller ctrller)
public com.amx.duet.devicesdk.device.type.DialerState getDialerState(com.amx.duet.devicesdk.device.type.Controller ctrller)
public java.lang.String getLastNumberDialed(com.amx.duet.devicesdk.device.type.Controller ctrller)
public com.amx.duet.devicesdk.device.type.PowerState getPower( )
public com.amx.duet.devicesdk.device.ISpeedDialDB getSpeedDialDB( )
public com.amx.duet.devicesdk.device.type.SurroundState getSurroundMode(com.amx.duet.devicesdk.device.type.Zone zone)
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public boolean isAudibleRingOn(com.amx.duet.devicesdk.device.type.Controller ctrller)
public boolean isAutoAnswerOn(com.amx.duet.devicesdk.device.type.Controller ctrller)
public boolean isLoudnessOn(com.amx.duet.devicesdk.device.type.Zone zone)
public boolean isOffHook(com.amx.duet.devicesdk.device.type.Controller ctrller)
public boolean isPrivacyOn( )
public boolean isVolumeMuteOn(com.amx.duet.devicesdk.device.type.Zone zone)
public void moveMenuCursor(com.amx.duet.devicesdk.device.type.Navigation direction)
public void nextSurroundMode(com.amx.duet.devicesdk.device.type.Zone zone)
public void pressMenuButton(com.amx.duet.devicesdk.device.type.Button button)
public void previousSurroundMode(com.amx.duet.devicesdk.device.type.Zone zone)
public void redialNumber(com.amx.duet.devicesdk.device.type.Controller ctrller)
public void selectMenuItem( )
public void setAudibleRingOn(com.amx.duet.devicesdk.device.type.Controller ctrller, boolean state)
public void setAutoAnswerOn(com.amx.duet.devicesdk.device.type.Controller ctrller, boolean state)
public void setBalance(com.amx.duet.devicesdk.device.type.Zone zone, int balance)
public void setBass(com.amx.duet.devicesdk.device.type.Zone zone, int bass)
public void setLoudnessOn(com.amx.duet.devicesdk.device.type.Zone zone, boolean state)
public void setOffHook(com.amx.duet.devicesdk.device.type.Controller ctrller, boolean state)
public void setPower(com.amx.duet.devicesdk.device.type.PowerState ps)
public void setPrivacyOn(boolean state)
public void setSurroundMode(com.amx.duet.devicesdk.device.type.Zone zone, com.amx.duet.devicesdk.device.type.SurroundState sm)
public void setTreble(com.amx.duet.devicesdk.device.type.Zone zone, int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)
public void train( )

The AudioMixer class provides a standard API for communication with and control of audio mixer devices. The AudioMixer API includes, but is not limited to, the following methods:
public AudioMixer( )
public AudioMixer(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustGain(com.amx.duet.devicesdk.device.type.Zone zone, int offset)
public void adjustTreble(com.amx.duet.devicesdk.device.type.Zone zone, int offset)
public void adjustVolume(com.amx.duet.devicesdk.device.type.Zone zone, int offset)
public void cycleGainMute(com.amx.duet.devicesdk.device.type.Zone zone)
public void cycleLoudness(com.amx.duet.devicesdk.device.type.Zone zone)
public void cycleMixerPreset( )
public void cyclePower( )
public void cycleSurroundMode(com.amx.duet.devicesdk.device.type.Zone zone)
public void cycleSwitcherPreset( )
public void cycleVolumeMute(com.amx.duet.devicesdk.device.type.Zone zone)
public void finalize( )
public int getBalance(com.amx.duet.devicesdk.device.type.Zone zone)
public int getBass(com.amx.duet.devicesdk.device.type.Zone zone)
public float getCrosspoint(int input, int output)
public int getGain(com.amx.duet.devicesdk.device.type.Zone zone)
public int getInput(com.amx.duet.devicesdk.device.type.SwitchLevel sl, int output)
public int getInputCount( )
public int getMixerPreset( )
public int[ ] getOutput(com.amx.duet.devicesdk.device.type.SwitchLevel sl, int input)
public int getOutputCount( )
public com.amx.duet.devicesdk.device.type.PowerState getPower( )
public com.amx.duet.devicesdk.device.type.SurroundState getSurroundMode(com.amx.duet.devicesdk.device.type.Zone zone)
public int getSwitcherPreset( )
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public boolean isBreakAwaySupported( )
public boolean isGainMuteOn(com.amx.duet.devicesdk.device.type.Zone zone)
public boolean isLoudnessOn(com.amx.duet.devicesdk.device.type.Zone zone)
public boolean isVolumeMuteOn(com.amx.duet.devicesdk.device.type.Zone zone)
public void nextSurroundMode(com.amx.duet.devicesdk.device.type.Zone zone)
public void nextSwitcherPreset( )
public void previousSurroundMode(com.amx.duet.devicesdk.device.type.Zone zone)
public void previousSwitcherPreset( )
public void saveMixerPreset(int preset)
public void saveSwitcherPreset(int preset)
public void setBalance(com.amx.duet.devicesdk.device.type.Zone zone, int balance)
public void setBass(com.amx.duet.devicesdk.device.type.Zone zone, int bass)
public void setCrosspoint(int input, int output, float value)
public void setCrosspoint(int input, int[]] output, float value)
public void setCrosspoint(int[ ] inputs, int[ ] outputs, float value)
public void setGain(com.amx.duet.devicesdk.device.type.Zone zone, int level)
public void setGainMuteOn(com.amx.duet.devicesdk.device.type.Zone zone, boolean state)
public void setLoudnessOn(com.amx.duet.devicesdk.device.type.Zone zone, boolean state)
public void setMixerPreset(int preset)
public void setPower(com.amx.duet.devicesdk.device.type.PowerState ps)
public void setSurroundMode(com.amx.duet.devicesdk.device.type.Zone zone, com.amx.duet.devicesdk.device.type.SurroundState sm)
public void setSwitcherPreset(int preset)
public void setTreble(com.amx.duet.devicesdk.device.type.Zone zone, int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)
public void switchInputToOutput(com.amx.duet.devicesdk.device.type.SwitchLevel sl int input, int output)
public void switchInputToOutput(com.amx.duet.devicesdk.device.type.SwitchLevel sl, int input, int[ ] output)
public void switchInputToOutput(com.amx.duet.devicesdk.device.type.SwitchLevel sl, int[ ] input, int[ ] output)

The AudioProcessor class provides a standard API for communication with and control of audio processor devices. The AudioProcessor API includes, but is not limited to, the following methods:
public AudioProcessor( )
public AudioProcessor(BundleContext bctxt, NetLinxDevice nd, java.util.Properties props)
public void adjustLevel(java.lang.String addr, int offset)
public void cycleAudioProcPreset(int preset)
public void cycleAudioProcPreset(java.lang.String addr, int preset)
public void cyclePower( )
public void finalize( )
public int getAudioProcPreset( )
public int getAudioProcPreset(java.lang.String addr)
public int getLevel(java.lang.String addr)
public com.amx.duet.devicesdk.device.type.PowerState getPower( )
public boolean isStateOn(java.lang.String addr)
public void saveAudioProcPreset(int preset)
public void saveAudioProcPreset(java.lang.String addr, int preset)
public void setAudioProcPreset(int preset)
public void setAudioProcPreset(java.lang.String addr, int preset)
public void setLevel(java.lang.String addr, int level)
public void setPower(com.amx.duet.devicesdk.device.type.PowerState ps)
public void setStateOn(java.lang.String addr, boolean state)

The AudioTunerDevice class provides a standard API for communication with and control of audio tuner devices. The AudioTunerDevice API includes, but is not limited to, the following methods:
public AudioTunerDevice( )
public AudioTunerDevice(BundleContext bctxt, NetLinxDevice nd, java.util.Properties props)
public void cycleBand( )
public void cycleDisplayInfo( )
public void cyclePower( )
public void cycleStationPreset( )
public void cycleStationPresetGroup( )
public void decrementStation( )
public void finalize( )
public com.amx.duet.devicesdk.device.type.TunerBand getBand( )
public com.amx.duet.devicesdk.device.type.PowerState getPower( )
public java.lang.String getStation( )
public int getStationPreset( )
public void gotoPreviousStation( )
public void incrementStation( )
public void nextStationPreset( )
public void previousStationPreset( )
public void scanStation(com.amx.duet.devicesdk.device.type.StationSearchCommand sc)
public void seekStation(com.amx.duet.devicesdk.device.type.StationSearchCommand sc)
public void setBand(com.amx.duet.devicesdk.device.type.TunerBand tb)
public void setPower(com.amx.duet.devicesdk.device.type.PowerState ps)
public void setStation(java.lang.String station)
public void setStationPreset(int preset)

The Camera class provides a standard API for communication with and control of camera devices. The Camera API includes, but is not limited to, the following methods:
public Camera( )
public Camera(BundleContext bctxt, NetLinxDevice nd, java.util.Properties props)
public void cycleAutoFocus( )
public void cycleAutoIris( )
public void cycleCameraPreset( )
public void cyclePower( )
public void finalize( )
public int getCameraPreset( )
public int getFocus( )
public int getFocusSpeed( )
public int getIris( )
public int getIrisSpeed( )
public int getPan( )
public int getPanSpeed( )
public com.amx.duet.devicesdk.device.type.PowerState getPower( )
public com.amx.duet.devicesdk.device.type.RampFocus getRampFocus( )
public com.amx.duet.devicesdk.device.type.RampIris getRampIris( )
public com.amx.duet.devicesdk.device.type.RampPan getRampPan( )
public com.amx.duet.devicesdk.device.type.RampTilt getRampTilt( )
public com.amx.duet.devicesdk.device.type.RampZoom getRampZoom( )
public int getTilt( )
public int getTiltSpeed( )
public int getZoom( )
public int getZoomSpeed( )
public boolean isAutoFocusOn( )
public boolean isAutoIrisOn( )
public void nextCameraPreset( )
public void previousCameraPreset( )
public void setAutoFocusOn(boolean state)
public void setAutoIrisOn(boolean state)
public void setCameraPreset(int preset)
public void setFocus(int focus)
public void setFocusSpeed(int speed)
public void setIris(int iris)
public void setIrisSpeed(int speed)
public void setPan(int pan)
public void setPanSpeed(int speed)
public void setPower(com.amx.duet.devicesdk.device.type.PowerState ps)
public void setRampFocus(com.amx.duet.devicesdk.device.type.RampFocus rf)
public void setRampIris(com.amx.duet.devicesdk.device.type.RampIris ri)
public void setRampPan(com.amx.duet.devicesdk.device.type.RampPan rp)
public void setRampPanTilt(com.amx.duet.devicesdk.device.type.RampPan rp. com.amx.duet.devicesdk.device.type.RampTilt rt)
public void setRampTilt(com.amx.duet.devicesdk.device.type.RampTilt rt)
public void setRampZoom(com.amx.duet.devicesdk.device.type.RampZoom rz)
public void setTilt(int tilt)
public void setTiltSpeed(int speed)
public void setZoom(int zoom)
public void setZoomSpeed(int speed)

The DigitalMediaPlayer class provides a standard API for communication with and control of digital media devices. The DigitalMediaPlayer API includes, but is not limited to, the following methods:
public DigitalMediaPlayer( )
public DigitalMediaPlayer(BundleContext bctxt, NetLinxDevice nd, java.util.Properties props)
public boolean addPlaylistItem(java.lang.String playlistRecordID, java.lang.String sourceRecordID)
public boolean clearPlaylist(java.lang.String playlistRecordID)
public void close(java.lang.String searchHandle)
public java.lang.String createPlaylist(java.lang.String name)
public void cyclePower( )
public void cycleRandom(com.amx.duet.devicesdk.device.type.Zone zone)
public void cycleRepeat(com.amx.duet.devicesdk.device.type.Zone zone)
public void cycleScanSpeed(com.amx.duet.devicesdk.device.type.Zone zone)
public boolean deletePlaylist(java.lang.String playlistRecordID)
public boolean deletePlaylistItem(java.lang.String playlistRecordID, java.lang.String sourceRecordID)
public void finalize( )
public com.amx.duet.devicesdk.device.type.DiscTransport getDiscTransport(com.amx.duet.devicesdk.device.type.Zone zone)
public java.net.URL getImage(com.amx.duet.devicesdk.device.type.Zone zone)
public com.amx.duet.devicesdk.device.type.MediaDiscInfo getMediaDiscInfo(com.amx.duet.devicesdk.device.type.Zone zone)
public com.amx.duet.devicesdk.device.type.MediaTitleInfo getMediaTitleInfo(com.amx.duet.devicesdk.device.type.Zone zone)
public com.amx.duet.devicesdk.device.type.MediaTrackInfo getMediaTrackInfo(com.amx.duet.devicesdk.device.type.Zone zone)
public java.lang.String getPlayingDescription(com.amx.duet.devicesdk.device.type.Zone zone)
public com.amx.duet.devicesdk.device.type.PowerState getPower( )
public com.amx.duet.devicesdk.device.type.RandomState getRandomState(com.amx.duet.devicesdk.device.type.Zone zone)
public com.amx.duet.devicesdk.device.type.RepeatState getRepeatState(com.amx.duet.devicesdk.device.type.Zone zone)
public com.amx.duet.devicesdk.device.type.ScanSpeed getScanSpeed(com.amx.duet.devicesdk.device.type.Zone zone)
public com.amx.duet.devicesdk.device.type.MediaCounter getTrackCounter(com.amx.duet.devicesdk.device.type.Zone zone)
public com.amx.duet.devicesdk.device.type.TrackInfo getTrackInfo(com.amx.duet.devicesdk.device.type.Zone zone)
public java.util.Properties getTrackProperties(com.amx.duet.devicesdk.device.type.Zone zone)
public void moveMenuCursor(com.amx.duet.devicesdk.device.type.Navigation direction)
public void pressMenuButton(com.amx.duet.devicesdk.device.type.Button button)
public boolean queryImage(com.amx.duet.devicesdk.device.type.Record record)
public boolean queryMediaInfo(com.amx.duet.devicesdk.device.type.MediaRecord mr)
public boolean queryNext(com.amx.duet.devicesdk.device.type.SearchInfo si)
public boolean queryPrevious(com.amx.duet.devicesdk.device.type.SearchInfo si)
public boolean savePlaylist(java.lang.String playlistRecordID)
public java.lang.String search(com.amx.duet.devicesdk.device.type.SearchRequest sr)
public void selectMenuItem( )
public void setDiscTransport(com.amx.duet.devicesdk.device.type.Zone zone, com.amx.duet.devicesdk.device.type.DiscTransport transport)
public void setDiscTransport(com.amx.duet.devicesdk.device.type.Zone zone, com.amx.duet.devicesdk.device.type.DiscTransport transport, com.amx.duet.devicesdk.device.type.ScanSpeed ss)
public void setPlayPosition(com.amx.duet.devicesdk.device.type.Zone zone, com.amx.duet.devicesdk.device.type.MediaCounter relativeCounter)
public void setPlayPosition(com.amx.duet.devicesdk.device.type.Zone zone, java.lang.String recordID)
public void setPower(com.amx.duet.devicesdk.device.type.PowerState ps)
public void setRandomState(com.amx.duet.devicesdk.device.type.Zone zone, com.amx.duet.devicesdk.device.type.RandomState rs)
public void setRepeatState(com.amx.duet.devicesdk.device.type.Zone zone, com.amx.duet.devicesdk.device.type.RepeatState rs)
public void stepFrame(com.amx.duet.devicesdk.device.type.Zone zone, com.amx.duet.devicesdk.device.type.Direction dir)

The DigitalSatelliteSystem class provides a standard API for communication with and control of digital satellite devices. The DigitalSatelliteSystem API includes, but is not limited to, the following methods:
public DigitalSatelliteSystem( )
public DigitalSatelliteSystem(BundleContext bctxt, NetLinxDevice nd, java.util.Properties props)
public void cycleBand( )
public void cycleDisplayInfo( )
public void cyclePower( )
public void cycleStationPreset( )
public void cycleStationPresetGroup( )
public void decrementStation( )
public void finalize( )
public com.amx.duet.devicesdk.device.type.TunerBand getBand( )
public com.amx.duet.devicesdk.device.type.PowerState getPower( )
public java.lang.String getStation( )
public int getStationPreset( )
public void gotoPreviousStation( )
public void incrementStation( )
public void moveMenuCursor(com.amx.duet.devicesdk.device.type.Navigation direction)
public void nextStationPreset( )
public void pressMenuButton(com.amx.duet.devicesdk.device.type.Button button)
public void previousStationPreset( )
public void scanStation(com.amx.duet.devicesdk.device.type.StationSearchCommand sc)
public void seekStation(com.amx.duet.devicesdk.device.type.StationSearchCommand sc)
public void selectMenuItem( )
public void setBand(com.amx.duet.devicesdk.device.type.TunerBand tb)
public void setPower(com.amx.duet.devicesdk.device.type.PowerState ps)
public void setStation(java.lang.String station)
public void setStationPreset(int preset)

The DigitalVideoRecorder class provides a standard API for communication with and control of digital video recorder (DVR) devices. The DigitalVideoRecorder API includes, but is not limited to, the following methods:
public DigitalVideoRecorder( )
public DigitalVideoRecorder(BundleContext bctxt, NetLinxDevice nd, java.util.Properties props)
public void cycleBand( )
public void cycleDisplayInfo( )
public void cycleInputSource(com.amx.duet.devicesdk.device.type.Zone zone)
public void cyclePower( )
public void cycleScanSpeed(com.amx.duet.devicesdk.device.type.Zone zone)
public void cycleStationPreset( )
public void cycleStationPresetGroup( )
public void decrementStation( )
public void finalize( )
public com.amx.duet.devicesdk.device.type.TunerBand getBand( )
public com.amx.duet.devicesdk.device.type.DiscTransport getDiscTransport(com.amx.duet.devicesdk.device.type.Zone zone)
public com.amx.duet.devicesdk.device.type.InputSourceSelect getInputSource(com.amx.duet.devicesdk.device.type.Zone zone)
public com.amx.duet.devicesdk.device.type.PowerState getPower( )
public com.amx.duet.devicesdk.device.type.ScanSpeed getScanSpeed(com.amx.duet.devicesdk.device.type.Zone zone)
public java.lang.String getStation( )
public int getStationPreset( )
public com.amx.duet.devicesdk.device.type.MediaCounter getTrackCounter(com.amx.duet.devicesdk.device.type.Zone zone)
public com.amx.duet.devicesdk.device.type.TrackInfo getTrackInfo(com.amx.duet.devicesdk.device.type.Zone zone)
public java.util.Properties getTrackProperties(com.amx.duet.devicesdk.device.type.Zone zone)
public void gotoPreviousStation( )
public void incrementStation( )
public void moveMenuCursor(com.amx.duet.devicesdk.device.type.Navigation direction)
public void nextStationPreset( )
public void pressMenuButton(com.amx.duet.devicesdk.device.type.Button button)
public void previousStationPreset( )
public void scanStation(com.amx.duet.devicesdk.device.type.StationSearchCommand sc)
public void seekStation(com.amx.duet.devicesdk.device.type.StationSearchCommand sc)
public void selectMenuItem( )
public void setBand(com.amx.duet.devicesdk.device.type.TunerBand tb)
public void setDiscTransport(com.amx.duet.devicesdk.device.type.Zone zone, com.amx.duet.devicesdk.device.type.DiscTransport transport)
public void setDiscTransport(com.amx.duet.devicesdk.device.type.Zone zone, com.amx.duet.devicesdk.device.type.DiscTransport transport, com.amx.duet.devicesdk.device.type.ScanSpeed ss)
public void setInputSource(com.amx.duet.devicesdk.device.type.Zone zone, com.amx.duet.devicesdk.device.type.InputSourceSelect sourceSelect)
public void setPlayPosition(com.amx.duet.devicesdk.device.type.Zone zone, com.amx.duet.devicesdk.device.type.MediaCounter relativeCounter)
public void setPlayPosition(com.amx.duet.devicesdk.device.type.Zone zone, int trackNumber)
public void setPlayPosition(com.amx.duet.devicesdk.device.type.Zone zone, int trackNumber, com.amx.duet.devicesdk.device.type.MediaCounter relativeCounter)
public void setPower(com.amx.duet.devicesdk.device.type.PowerState ps)
public void setStation(java.lang.String station)
public void setStationPreset(int preset)
public void stepFrame(com.amx.duet.devicesdk.device.type.Zone zone, com.amx.duet.devicesdk.device.type.Direction dir)

The DiscDevice class provides a standard API for communication with and control of digital disc devices. The DiscDevice API includes, but is not limited to, the following methods:
public DiscDevice( )
public DiscDevice(BundleContext bctxt, NetLinxDevice nd, java.util.Properties props)
public void cyclePower( )
public void cycleRandom(com.amx.duet.devicesdk.device.type.Zone zone)
public void cycleRepeat(com.amx.duet.devicesdk.device.type.Zone zone)
public void cycleScanSpeed(com.amx.duet.devicesdk.device.type.Zone zone)
public void finalize( )
public int getDiscCount( )
public com.amx.duet.devicesdk.device.type.DiscInfo getDiscInfo(com.amx.duet.devicesdk.device.type.Zone zone)
public java.util.Properties getDiscProperties(com.amx.duet.devicesdk.device.type.Zone zone)
public com.amx.duet.devicesdk.device.type.DiscTransport getDiscTransport(com.amx.duet.devicesdk.device.type.Zone zone)
public com.amx.duet.devicesdk.device.type.PlayPositionInfo getPlayPositionInfo(com.amx.duet.devicesdk.device.type.Zone zone)
public com.amx.duet.devicesdk.device.type.PowerState getPower( )
public com.amx.duet.devicesdk.device.type.RandomState getRandomState(com.amx.duet.devicesdk.device.type.Zone zone)
public com.amx.duet.devicesdk.device.type.RepeatState getRepeatState(com.amx.duet.devicesdk.device.type.Zone zone)
public com.amx.duet.devicesdk.device.type.ScanSpeed getScanSpeed(com.amx.duet.devicesdk.device.type.Zone zone)
public com.amx.duet.devicesdk.device.type.TitleInfo getTitleInfo(com.amx.duet.devicesdk.device.type.Zone zone)
public java.util.Properties getTitleProperties(com.amx.duet.devicesdk.device.type.Zone zone)
public com.amx.duet.devicesdk.device.type.MediaCounter getTrackCounter(com.amx.duet.devicesdk.device.type.Zone zone)
public com.amx.duet.devicesdk.device.type.TrackInfo getTrackInfo(com.amx.duet.devicesdk.device.type.Zone zone)
public java.util.Properties getTrackProperties(com.amx.duet.devicesdk.device.type.Zone zone)
public void moveMenuCursor(com.amx.duet.devicesdk.device.type.Navigation direction)
public void pressMenuButton(com.amx.duet.devicesdk.device.type.Button button)
public void selectMenuItem( )
public void setDisc(com.amx.duet.devicesdk.device.type.Zone zone, com.amx.duet.devicesdk.device.type.Direction direction)
public void setDisc(com.amx.duet.devicesdk.device.type.Zone zone, int discNumber)
public void setDiscTransport(com.amx.duet.devicesdk.device.type.Zone zone, com.amx.duet.devicesdk.device.type.DiscTransport transport)
public void setDiscTransport(com.amx.duet.devicesdk.device.type.Zone zone, com.amx.duet.devicesdk.device.type.DiscTransport transport, com.amx.duet.devicesdk.device.type.ScanSpeed ss)
public void setPlayPosition(com.amx.duet.devicesdk.device.type.Zone zone. com.amx.duet.devicesdk.device.type.MediaCounter relativeCounter)
public void setPlayPosition(com.amx.duet.devicesdk.device.type.Zone zone, int trackNumber)
public void setPlayPosition(com.amx.duet.devicesdk.device.type.Zone zone, int trackNumber, com.amx.duet.devicesdk.device.type.MediaCounter relativeCounter)
public void setPlayPosition(com.amx.duet.devicesdk.device.type.Zone zone, int titleNumber, int trackNumber)
public void setPlayPosition(com.amx.duet.devicesdk.device.type.Zone zone, int titleNumber, int trackNumber, com.amx.duet.devicesdk.device.type.MediaCounter relativeCounter)
public void setPower(com.amx.duet.devicesdk.device.type.PowerState ps)
public void setRandomState(com.amx.duet.devicesdk.device.type.Zone zone, com.amx.duet.devicesdk.device.type.RandomState rs)
public void setRepeatState(com.amx.duet.devicesdk.device.type.Zone zone, com.amx.duet.devicesdk.device.type.RepeatState rs)
public void stepFrame(com.amx.duet.devicesdk.device.type.Zone zone, com.amx.duet.devicesdk.device.type.Direction dir)

The DocumentCamera class provides a standard API for communication with and control of digital disc devices. The DocumentCamera API includes, but is not limited to, the following methods:
public DocumentCamera( )
public DocumentCamera(BundleContext bctxt, NetLinxDevice nd, java.util.Properties props)
public void cycleAutoFocus( )
public void cycleAutoIris( )
public void cycleInputSource(com.amx.duet.devicesdk.device.type.Zone zone)
public void cycleLight( )
public void cyclePower( )
public void finalize( )
public int getFocusSpeed( )
public com.amx.duet.devicesdk.device.type.InputSourceSelect getInputsource(com.amx.duet.devicesdk.device.type.Zone zone)
public int getIris( )
public int getIrisSpeed( )
public com.amx.duet.devicesdk.device.type.PowerState getPower( )
public com.amx.duet.devicesdk.device.type.RampFocus getRampFocus( )
public com.amx.duet.devicesdk.device.type.RampIris getRampIris( )
public com.amx.duet.devicesdk.device.type.RampZoom getRampZoon( )
public int getZoom( )
public int getZoomSpeed( )
public boolean isAutoFocusOn( )
public boolean isAutoIrisOn( )
public boolean isLowerLightOn( )
public boolean isUpperLightOn( )
public void setAutoFocusOn(boolean state)
public void setAutoIrisOn(boolean state)
public void setFocus(int focus)
public void setFocusSpeed(int speed)
public void setInputSource(com.amx.duet.devicesdk.device.type.Zone zone, com.amx.duet.devicesdk.device.type.InputSourceSelect sourceSelect)
public void setIris(int iris)
public void setIrisSpeed(int speed)
public void setLowerLightOn(boolean state)
public void setPower(com.amx.duet.devicesdk.device.type.PowerState ps)
public void setRampFocus(com.amx.duet.devicesdk.device.type.RampFocus rf)
public void setRampIris(com.amx.duet.devicesdk.device.type.RampIris ri)
public void setRampZoom(com.amx.duet.devicesdk.device.type.RampZoom rz)
public void setUpperLightOn(boolean state)
public void setZoom(int zoom)
public void setZoomSpeed(int speed)

The DualWellCassetteDeck class provides a standard API for communication with and control of dual well cassette desk devices. The DualWellCassetteDeck API includes, but is not limited to, the following methods:
public DualWellCassetteDeck(BundleContext bctxt, NetLinxDevice nd, java.util.Properties props)
public void cyclePower( )
public void cycleSearchSpeed( )
public int cycleTapeDeck( )
public void cycleTapeSide( )
public void ejectTape( )
public void finalize( )
public com.amx.duet.devicesdk.device.type.PowerState getPower( )
public com.amx.duet.devicesdk.device.type.TapeRecordSpeed getRecordSpeed( )
public com.amx.duet.devicesdk.device.type.SearchSpeed getSearchSpeed( )
public com.amx.duet.devicesdk.device.type.MediaCounter getTapeCounter( )
public int getTapeDeck( )
public com.amx.duet.devicesdk.device.type.MediaSide getTapeSide( )
public com.amx.duet.devicesdk.device.type.TapeTransport getTapeTransport( )
public boolean isRecordLocked( )
public boolean isRecordMuteOn( )
public boolean isTapeLoaded( )
public void resetCounter( )
public void setPower(com.amx.duet.devicesdk.device.type.PowerState ps)
public void setRecordMuteOn(boolean state)
public void setRecordSpeed(com.amx.duet.devicesdk.device.type.TapeRecordSpeed trs)
public void setTapeDeck(int deck)
public void setTapeSide(com.amx.duet.devicesdk.device.type.MediaSide ms)
public void setTapeTransport(com.amx.duet.devicesdk.device.type.TapeTransport tt)
public void setTapeTransport(com.amx.duet.devicesdk.device.type.TapeTransport tt, com.amx.duet.devicesdk.device.type.SearchSpeed ss)

The HVAC class provides a standard API for communication with and control of heating, ventilation and air conditioning systems. The HVAC API includes, but is not limited to, the following methods:
public HVAC( )
public HVAC(BundleContext bctxt, NetLinxDevice nd, java.util.Properties props)
public void cycleFanState(com.amx.duet.devicesdk.device.type.Zone zone)
public void cycleHVACState(com.amx.duet.devicesdk.device.type.Zone zone)
public void cycleHumidifyState(com.amx.duet.devicesdk.device.type.Zone zone)
public void decrementCoolSetpoint(com.amx.duet.devicesdk.device.type.Zone zone)
public void decrementDehumidifySetpoint(com.amx.duet.devicesdk.device.type.Zone zone)
public void decrementHeatSetpoint(com.amx.duet.devicesdk.device.type.Zone zone)
public void decrementHumidifySetpoint(com.amx.duet.devicesdk.device.type.Zone zone)
public void finalize( )
public int getCoolSetpoint(com.amx.duet.devicesdk.device.type.Zone zone)
public int getDehumidifySetpoint(com.amx.duet.devicesdk.device.type.Zone zone) public com.amx.duet.devicesdk.device.type.FanState getFanState(com.amx.duet.devicesdk.device.type.Zone zone)
public com.amx.duet.devicesdk.device.type.PowerState getFanStatus(com.amx.duet.devicesdk.device.type.Zone zone)
public com.amx.duet.devicesdk.device.type.HVACState getHVACState(com.amx.duet.devicesdk.device.type.Zone zone)
public com.amx.duet.devicesdk.device.type.HVACStatus getHVACStatus(com.amx.duet.devicesdk.device.type.Zone zone)
public int getHeatSetpoint(com.amx.duet.devicesdk.device.type.Zone zone)
public int getHumidifySetpoint(com.amx.duet.devicesdk.device.type.Zone zone)
public com.amx.duet.devicesdk.device.type.HumidifyState getHumidifyState(com.amx.duet.devicesdk.device.type.Zone zone)
public com.amx.duet.devicesdk.device.type.HumidifyStatus getHumidifyStatus(com.amx.duet.devicesdk.device.type.Zone zone)
public float getIndoorHumidity(com.amx.duet.devicesdk.device.type.Zone zone)
public float getIndoorTemperature(com.amx.duet.devicesdk.device.type.Zone zone)
public float getOutdoorHumidity(com.amx.duet.devicesdk.device.type.Zone zone)
public float getOutdoorTemperature(com.amx.duet.devicesdk.device.type.Zone zone)
public com.amx.duet.devicesdk.device.type.TemperatureScale getTemperatureScale( )
public int getZoneCount( )
public void incrementCoolSetpoint(com.amx.duet.devicesdk.device.type.Zone zone)
public void incrementDehumidifySetpoint(com.amx.duet.devicesdk.device.type.Zone zone)
public void incrementHeatSetpoint(com.amx.duet.devicesdk.device.type.Zone zone)
public void incrementHumidifySetpoint(com.amx.duet.devicesdk.device.type.Zone zone)
public boolean isThermostatHoldOn(com.amx.duet.devicesdk.device.type.Zone zone)
public boolean isThermostatLockOn(com.amx.duet.devicesdk.device.type.Zone zone)
public void setCoolSetpoint(com.amx.duet.devicesdk.device.type.Zone zone, int setpoint)
public void setDehumidifySetpoint(com.amx.duet.devicesdk.device.type.Zone zone, int setpoint)
public void setFanState(com.amx.duet.devicesdk.device.type.Zone zone. com.amx.duet.devicesdk.device.type.FanState fs)
public void setHVACState(com.amx.duet.devicesdk.device.type.Zone zone, com.amx.duet.devicesdk.device.type.HVACState hs)
public void setHeatSetpoint(com.amx.duet.devicesdk.device.type.Zone zone, int setpoint)
public void setHumidifySetpoint(com.amx.duet.devicesdk.device.type.Zone zone, int setpoint)
public void setHumidifyState(com.amx.duet.devicesdk.device.type.Zone zone, com.amx.duet.devicesdk.device.type.HumidifyState hs)
public void setTemperatureScale(com.amx.duet.devicesdk.device.type.TemperatureScale ts)
public void setThermostatHoldOn(com.amx.duet.devicesdk.device.type.Zone zone, boolean state)
public void setThermostatLockOn(com.amx.duet.devicesdk.device.type.Zone zone, boolean state)

The KeypadController class provides a standard API for communication with and control of keypad controller devices. The KeypadController API includes, but is not limited to, the following methods:
public KeypadController( )
public KeypadController(BundleContext bctxt, NetLinxDevice nd, java.util.Properties props)
public void finalize( )
public com.amx.duet.devicesdk.device.type.ButtonState getButtonState(com.amx.duet.devicesdk.device.type.ButtonAddress kb)
public com.amx.duet.devicesdk.device.type.ButtonStatus getButtonStatus(com.amx.duet.devicesdk.device.type.ButtonAddress kb)
public void setButtonState(com.amx.duet.devicesdk.device.type.ButtonAddress kb, com.amx.duet.devicesdk.device.type.ButtonState bs)
public void setButtonStatus(com.amx.duet.devicesdk.device.type.ButtonAddress kb, com.amx.duet.devicesdk.device.type.ButtonStatus bs)

The Lights class provides a standard API for communication with and control of lighting devices. The Lights API includes, but is not limited to, the following methods:
public Lights( )
public Lights(BundleContext bctxt, NetLinxDevice nd, java.util.Properties props)
public void adjustLightLevel(com.amx.duet.devicesdk.device.type.LightAddress la, int offset)
public void adjustLightLevel(com.amx.duet.devicesdk.device.type.LightAddress la, int offset, int time)
public void cycleLight(com.amx.duet.devicesdk.device.type.LightAddress la)
public void finalize( )
public int getLightLevel(com.amx.duet.devicesdk.device.type.LightAddress la)
public boolean isLightOn(com.amx.duet.devicesdk.device.type.LightAddress la)
public void rampLightLevel(com.amx.duet.devicesdk.device.type.LightAddress la, com.amx.duet.devicesdk.device.type.RampLevel rl)
public void setLightLevel(com.amx.duet.devicesdk.device.type.LightAddress la, int percentage)
public void setLightLevel(com.amx.duet.devicesdk.device.type.LightAddress la, int percentage, int time)
public void setLightOn(com.amx.duet.devicesdk.device.type.LightAddress la)
public void setLightOn(com.amx.duet.devicesdk.device.type.LightAddress la, boolean state)

The Monitor class provides a standard API for communication with and control of monitor devices. The Monitor API includes, but is not limited to, the following methods:
public Monitor( )
public Monitor(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustBrightness(int offset)
public void adjustColor(int offset)
public void adjustContrast(int offset)
public void adjustSharpness(int offset)
public void adjustTint(int offset)
public void adjustTreble(com.amx.duet.devicesdk.device.type.Zone zone, int offset)
public void adjustVolume(com.amx.duet.devicesdk.device.type.Zone zone, int offset)
public void cycleAspectRatio( )
public void cycleClockDisplay( )
public void cycleFreeze( )
public void cycleInputSource(com.amx.duet.devicesdk.device.type.Zone zone)
public void cycleLoudness(com.amx.duet.devicesdk.device.type.Zone zone)
public void cyclePIP( )
public void cyclePIPPosition( )
public void cyclePictureMute( )
public void cyclePower( )
public void cycleSurroundMode(com.amx.duet.devicesdk.device.type.Zone zone)
public void cycleVolumeMute(com.amx.duet.devicesdk.device.type.Zone zone)
public void finalize( )
public com.amx.duet.devicesdk.device.type.MultiScreenSelect getActiveWindow( )
public com.amx.duet.devicesdk.device.type.AspectRatio getAspectRatio( )
public int getBalance(com.amx.duet.devicesdk.device.type.Zone zone)
public int getBass(com.amx.duet.devicesdk.device.type.Zone zone)
public int getBrightness( )
public int getColor( )
public int getContrast( )
public com.amx.duet.devicesdk.device.type.InputSourceSelect getInputSource(com.amx.duet.devicesdk.device.type.Zone zone)
public com.amx.duet.devicesdk.device.type.PowerState getPower( )
public int getSharpness( )
public com.amx.duet.devicesdk.device.type.SurroundState getSurroundMode(com.amx.duet.devicesdk.device.type.Zone zone)
public int getTint( )
public int getTreble(com.amx.duet.devicesdk.device.type.Zone zone)
public com.amx.duet.devicesdk.device.type.VideoState getVideoMode( )
public int getVolume(com.amx.duet.devicesdk.device.type.Zone zone)
public int getVolumePreset(com.amx.duet.devicesdk.device.type.Zone zone)
public boolean isFreezeOn( )
public boolean isLoudnessOn(com.amx.duet.devicesdk.device.type.Zone zone)
public boolean isPIPOn( )
public boolean isPictureMuteOn( )
public boolean isVolumeMuteOn(com.amx.duet.devicesdk.device.type.Zone zone)
public void moveMenuCursor(com.amx.duet.devicesdk.device.type.Navigation direction)
public void nextSurroundMode(com.amx.duet.devicesdk.device.type.Zone zone)
public void pressMenuButton(com.amx.duet.devicesdk.device.type.Button button)
public void previousSurroundMode(com.amx.duet.devicesdk.device.type.Zone zone)
public void selectMenuItem( )
public void setActiveWindow(com.amx.duet.devicesdk.device.type.MultiScreenSelect mss)
public void setAspectRatio(com.amx.duet.devicesdk.device.type.AspectRatio anAspectRatio)
public void setBalance(com.amx.duet.devicesdk.device.type.Zone zone, int balance)
public void setBass(com.amx.duet.devicesdk.device.type.Zone zone, int bass)
public void setBrightness(int level)
public void setColor(int level)
public void setContrast(int level)
public void setFreezeOn(boolean state)
public void setInputSource(com.amx.duet.devicesdk.device.type.Zone zone, com.amx.duet.devicesdk.device.type.InputSourceSelect sourceSelect)
public void setLoudnessOn(com.amx.duet.devicesdk.device.type.Zone zone, boolean state)
public void setPIPOn(boolean state)
public void setPictureMuteOn(boolean state)
public void setPower(com.amx.duet.devicesdk.device.type.PowerState ps)
public void setSharpness(int level)
public void setSurroundMode(com.amx.duet.devicesdk.device.type.Zone zone, com.amx.duet.devicesdk.device.type.SurroundState sm)
public void setTint(int level)
public void setTreble(com.amx.duet.devicesdk.device.type.Zone zone, int treble)
public void setVideoMode(com.amx.duet.devicesdk.device.type.VideoState vm)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)
public void swapPIP( )

The Motor class provides a standard API for communication with and control of motors. The Motor API includes, but is not limited to, the following methods:
public Motor( )
public Motor(BundleContext bctxt, NetLinxDevice nd, java.util.Properties props)
public void cycleMotorPreset(com.amx.duet.devicesdk.device.type.Zone zone)
public void finalize( )
public com.amx.duet.devicesdk.device.type.MotorDirection getMotorDirection(com.amx.duet.devicesdk.device.type.Zone zone)
public int getMotorPreset(com.amx.duet.devicesdk.device.type.Zone zone)
public int getPosition(com.amx.duet.devicesdk.device.type.Zone zone)
public void setMotorDirection(com.amx.duet.devicesdk.device.type.Zone zone, com.amx.duet.devicesdk.device.type.MotorDirection dir)
public void setMotorPreset(com.amx.duet.devicesdk.device.type.Zone zone, int preset)
public void setPosition(com.amx.duet.devicesdk.device.type.Zone zone, int percent)

The PoolSpa class provides a standard API for communication with and control of pools or spas. The PoolSpa API includes, but is not limited to, the following methods:
public PoolSpa( )
public PoolSpa(BundleContext bctxt, NetLinxDevice nd, java.util.Properties props)
public void displayOutsideAirTemperature( )
public void displayPoolSetpoint( )
public void displayPoolTemperature( )
public void displaySpaTemperature( )
public void finalize( )
public void poolAux1Off( )
public void poolAux1On( )
public void poolHeaterOff( )
public void poolHeaterOn( )
public void poolLightOff( )
public void poolLightOn( )
public void poolPumpOff( )
public void poolPumpOn( )
public void poolSetpointLower( )
public void poolSetpointRaise( )
public void poolSetpointSet( )
public void scheduleDisable( )
public void scheduleEnable( )
public void scheduleSetParameters( )
public void scheduleSetTime( )
public void selectPoolMode( )
public void selectSpaMode( )
public void spaBlowerOff( )
public void spaBlowerOn( )
public void spaHeaterOff( )
public void spaHeaterOn( )
public void spaJetsHigh( )
public void spaJetsLow( )
public void spaJetsMedium( )
public void spaJetsOff( )
public void spaLightsOff( )
public void spaLightsOn( )
public void spaSetpointDisplay( )
public void spaSetpointLower( )
public void spaSetpointRaise( )
public void spaSetpointSet( )
public void spaSolarOff( )
public void spaSolarOn( )

The PreAmpSurroundSoundProcessor class provides a standard API for communication with and control of pre-amp surround sound processor devices. The PreAmpSurroundSoundProcessor API includes, but is not limited to, the following methods:
public PreAmpSurroundSoundProcessor( )
public PreAmpSurroundSoundProcessor(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustTreble(com.amx.duet.devicesdk.device.type.Zone zone, int offset)
public void adjustVolume(com.amx.duet.devicesdk.device.type.Zone zone, int offset)
public void cycleInputSource(com.amx.duet.devicesdk.device.type.Zone zone)
public void cycleLoudness(com.amx.duet.devicesdk.device.type.Zone zone)
public void cyclePower( )
public void cycleSurroundMode(com.amx.duet.devicesdk.device.type.Zone zone)
public void cycleVolumeMute(com.amx.duet.devicesdk.device.type.Zone zone)
public void finalize( )
public int getBalance(com.amx.duet.devicesdk.device.type.Zone zone)
public int getBass(com.amx.duet.devicesdk.device.type.Zone zone)
public com.amx.duet.devicesdk.device.type.InputSourceSelect getInputSource(com.amx.duet.devicesdk.device.type.Zone zone)
public com.amx.duet.devicesdk.device.type.PowerState getPower( )
public com.amx.duet.devicesdk.device.type.SurroundState getSurroundMode(com.amx.duet.devicesdk.device.type.Zone zone)
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public boolean isLoudnessOn(com.amx.duet.devicesdk.device.type.Zone zone)
public boolean isVolumeMuteOn(com.amx.duet.devicesdk.device.type.Zone zone)
public void moveMenuCursor(com.amx.duet.devicesdk.device.type.Navigation direction)
public void nextSurroundMode(com.amx.duet.devicesdk.device.type.Zone zone)
public void pressMenuButton(com.amx.duet.devicesdk.device.type.Button button)
public void previousSurroundMode(com.amx.duet.devicesdk.device.type.Zone zone)
public void selectMenuItem( )
public void setBalance(com.amx.duet.devicesdk.device.type.Zone zone, int balance)
public void setBass(com.amx.duet.devicesdk.device.type.Zone zone, int bass)
public void setInputSource(com.amx.duet.devicesdk.device.type.Zone zone, com.amx.duet.devicesdk.device.type.InputSourceSelect sourceSelect)
public void setLoudnessOn(com.amx.duet.devicesdk.device.type.Zone zone, boolean state)
public void setPower(com.amx.duet.devicesdk.device.type.PowerState ps)
public void setSurroundMode(com.amx.duet.devicesdk.device.type.Zone zone, com.amx.duet.devicesdk.device.type.SurroundState sm)
public void setTreble(com.amx.duet.devicesdk.device.type.Zone zone, int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)

The Receiver class provides a standard API for communication with and control of receiver devices. The Receiver API includes, but is not limited to, the following methods:
public Receiver( )
public Receiver(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustTreble(com.amx.duet.devicesdk.device.type.Zone zone, int offset)
public void adjustVolume(com.amx.duet.devicesdk.device.type.Zone zone, int offset)
public void cycleBand( )
public void cycleDisplayInfo( )
public void cycleInputSource(com.amx.duet.devicesdk.device.type.Zone zone)
public void cycleLoudness(com.amx.duet.devicesdk.device.type.Zone zone)
public void cyclePower( )
public void cycleStationPreset( )
public void cycleStationPresetGroup( )
public void cycleSurroundMode(com.amx.duet.devicesdk.device.type.Zone zone)
public void cycleVolumeMute(com.amx.duet.devicesdk.device.type.Zone zone)
public void decrementStation( )
public void finalize( )
public int getBalance(com.amx.duet.devicesdk.device.type.Zone zone)
public com.amx.duet.devicesdk.device.type.TunerBand getBand( )
public int getBass(com.amx.duet.devicesdk.device.type.Zone zone)
public com.amx.duet.devicesdk.device.type.InputSourceSelect getInputSource(com.amx.duet.devicesdk.device.type.Zone zone)
public com.amx.duet.devicesdk.device.type.PowerState getPower( )
public java.lang.String getStation( )
public int getStationPreset( )
public com.amx.duet.devicesdk.device.type.SurroundState getSurroundMode(com.amx.duet.devicesdk.device.type.Zone zone)
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public void gotoPreviousStation( )
public void incrementStation( )
public boolean isLoudnessOn(com.amx.duet.devicesdk.device.type.Zone zone)
public boolean isVolumeMuteOn(com.amx.duet.devicesdk.device.type.Zone zone)
public void moveMenuCursor(com.amx.duet.devicesdk.device.type.Navigation direction)
public void nextStationPreset( )
public void nextSurroundMode(com.amx.duet.devicesdk.device.type.Zone zone)
public void pressMenuButton(com.amx.duet.devicesdk.device.type.Button button)
public void previousStationPreset( )
public void previousSurroundMode(com.amx.duet.devicesdk.device.type.Zone zone)
public void scanStation(com.amx.duet.devicesdk.device.type.StationSearchCommand sc)
public void seekStation(com.amx.duet.devicesdk.device.type.StationSearchCommand sc)
public void selectMenuItem( )
public void setBalance(com.amx.duet.devicesdk.device.type.Zone zone, int balance)
public void setBand(com.amx.duet.devicesdk.device.type.TunerBand tb)
public void setBass(com.amx.duet.devicesdk.device.type.Zone zone, int bass)
public void setInputSource(com.amx.duet.devicesdk.device.type.Zone zone,
com.amx.duet.devicesdk.device.type.InputSourceSelect sourceSelect)
public void setLoudnessOn(com.amx.duet.devicesdk.device.type.Zone zone, boolean state)
public void setPower(com.amx.duet.devicesdk.device.type.PowerState ps)
public void setStation(java.lang.String station)
public void setStationPreset(int preset)
public void setSurroundMode(com.amx.duet.devicesdk.device.type.Zone zone,
com.amx.duet.devicesdk.device.type.SurroundState sm)
public void setTreble(com.amx.duet.devicesdk.device.type.Zone zone int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)

The SecuritySystem class provides a standard API for communication with and control of security systems. The SecuritySystem API includes, but is not limited to, the following methods:
public SecuritySystem( )
public SecuritySystem(BundleContext bctxt, NetLinxDevice nd, java.util.Properties props)
public void finalize( )
public int getPartitionCount( )
public int getPointCount( )
public com.amx.duet.devicesdk.device.type.SecurityPointState getPointState(com.amx.duet.devicesdk.device.type.SecurityPoint secPoint)
public com.amx.duet.devicesdk.device.type.SecurityPointStatus getPointStatus(com.amx.duet.devicesdk.device.type.SecurityPoint secPoint)
public com.amx.duet.devicesdk.device.type.SecurityState getSecurityState( )
public com.amx.duet.devicesdk.device.type.SecurityState getSecurityState(com.amx.duet.devicesdk.device.type.SecurityPartition partition)
public com.amx.duet.devicesdk.device.type.SecurityStatus getSecurityStatus( )
public com.amx.duet.devicesdk.device.type.SecurityStatus getSecurityStatus(com.amx.duet.devicesdk.device.type.SecurityPartition partition)
public java.lang.String getText(com.amx.duet.devicesdk.device.type.Keypad kp)
public boolean isOKToArm( )
public boolean isOKToArm(com.amx.duet.devicesdk.device.type.SecurityPartition partition)
public void pressSecurityButton(com.amx.duet.devicesdk.device.type.Keypad keypad, com.amx.duet.devicesdk.device.type.Button button)
public void setPartitionCount(int partitionCount)
public void setPointCount(int pointCount)
public void setPointState(com.amx.duet.devicesdk.device.type.SecurityPoint secPoint, com.amx.duet.devicesdk.device.type.SecurityPointState ps, com.amx.duet.devicesdk.device.type.Password pw)
public void setSecurityState(com.amx.duet.devicesdk.device.type.SecurityPartition partition, com.amx.duet.devicesdk.device.type.SecurityState ss, com.amx.duet.devicesdk.device.type.Password pw)
public void setSecurityState(com.amx.duet.devicesdk.device.type.SecurityState ss, com.amx.duet.devicesdk.device.type.Password pw)

The SettopBox class provides a standard API for communication with and control of settop-box devices. The SettopBox API includes, but is not limited to, the following methods:
public SettopBox( )
public SettopBox(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustTreble(com.amx.duet.devicesdk.device.type.Zone zone, int offset)
public void adjustVolume(com.amx.duet.devicesdk.device.type.Zone zone, int offset)
public void cycleABSwitch( )
public void cycleBand( )
public void cycleDisplayInfo( )
public void cycleLoudness(com.amx.duet.devicesdk.device.type.Zone zone)
public void cyclePower( )
public void cycleStationPreset( )
public void cycleStationPresetGroup( )
public void cycleSurroundMode(com.amx.duet.devicesdk.device.type.Zone zone)
public void cycleVolumeMute(com.amx.duet.devicesdk.device.type.Zone zone)
public void decrementStation( )
public void finalize( )
public int getBalance(com.amx.duet.devicesdk.device.type.Zone zone)
public com.amx.duet.devicesdk.device.type.TunerBand getBand( )
public int getBass(com.amx.duet.devicesdk.device.type.Zone zone)
public com.amx.duet.devicesdk.device.type.PowerState getPower( )
public java.lang.String getStation( )
public int getStationPreset( )
public com.amx.duet.devicesdk.device.type.SurroundState getSurroundMode(com.amx.duet.devicesdk.device.type.Zone zone)
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public void gotoPreviousStation( )
public void incrementStation( )
public boolean isBSwitchOn( )
public boolean isLoudnessOn(com.amx.duet.devicesdk.device.type.Zone zone)
public boolean isVolumeMuteOn(com.amx.duet.devicesdk.device.type.Zone zone)
public void moveMenuCursor(com.amx.duet.devicesdk.device.type.Navigation direction)
public void nextStationPreset( )
public void nextSurroundMode(com.amx.duet.devicesdk.device.type.Zone zone)
public void pressMenuButton(com.amx.duet.devicesdk.device.type.Button button)
public void previousStationPreset( )
public void previousSurroundMode(com.amx.duet.devicesdk.device.type.Zone zone)
public void scanStation(com.amx.duet.devicesdk.device.type.StationSearchCommand sc)
public void seekStation(com.amx.duet.devicesdk.device.type.StationSearchCommand sc)
public void selectMenuItem( )
public void setBSwitchOn(boolean state)
public void setBalance(com.amx.duet.devicesdk.device.type.Zone zone, int balance)
public void setBand(com.amx.duet.devicesdk.device.type.TunerBand tb)
public void setBass(com.amx.duet.devicesdk.device.type.Zone zone, int bass)
public void setLoudnessOn(com.amx.duet.devicesdk.device.type.Zone zone, boolean state)
public void setPower(com.amx.duet.devicesdk.device.type.PowerState ps)
public void setStation(java.lang.String station)
public void setStationPreset(int preset)
public void setSurroundMode(com.amx.duet.devicesdk.device.type.Zone zone,
com.amx.duet.devicesdk.device.type.SurroundState sm)
public void setTreble(com.amx.duet.devicesdk.device.type.Zone zone, int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)

The SlideProjector class provides a standard API for communication with and control of slide projector devices. The SlideProjector API includes, but is not limited to, the following methods:
public SlideProjector( )
public SlideProjector(BundleContext bctxt, NetLinxDevice nd, java.util.Properties props)
public void cyclePower( )
public void directSlideAccess1Thru32Slides( )
public void finalize( )
public void focusIn( )
public void focusOut( )
public com.amx.duet.devicesdk.device.type.PowerState getPower( )
public void lampOff( )
public void lampOn( )
public void nextSlide( )
public void previousSlide( )
public void setPower(com.amx.duet.devicesdk.device.type.PowerState ps)

The SpeedDialDB class provides a standard API for communication with and control of speed dial database devices. The SpeedDialDB API includes, but is not limited to, the following methods:
public SpeedDialDB( )
public SpeedDialDB(BundleContext bctxt, NetLinxDevice nd, java.util.Properties props)
public int addSpeedDialEntry(com.amx.duet.devicesdk.device.type.SpeedDialEntry pbe)
public void deleteSpeedDialEntry(com.amx.duet.devicesdk.device.type.SpeedDialEntry pbe)
public void deleteSpeedDialEntry(int index)
public void finalize( )
public com.amx.duet.devicesdk.device.type.SpeedDialEntry getNextSpeedDialEntry(int index)
public com.amx.duet.devicesdk.device.type.SpeedDialEntry getPreviousSpeedDialEntry(int index)
public com.amx.duet.devicesdk.device.type.SpeedDialEntry getSpeedDialEntry(int index)
public com.amx.duet.devicesdk.device.type.SpeedDialEntry[ ] searchSpeedDialEntries(java.lang.String label)
public void setSpeedDialEntry(int index, com.amx.duet.devicesdk.device.type.SpeedDialEntry pbe)
public int size( )

The Switcher class provides a standard API for communication with and control of switcher devices. The Switcher API includes, but is not limited to, the following methods:
public Switcher( )
public Switcher(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustGain(com.amx.duet.devicesdk.device.type.Zone zone, int offset)
public void adjustTreble(com.amx.duet.devicesdk.device.type.Zone zone, int offset)
public void adjustVolunie(com.amx.duet.devicesdk.device.type.Zone zone, int offset)
public void cycleGainMute(com.amx.duet.devicesdk.device.type.Zone zone)
public void cycleLoudness(com.amx.duet.devicesdk.device.type.Zone zone)
public void cyclePower( )
public void cycleSurroundMode(com.amx.duet.devicesdk.device.type.Zone zone)
public void cvcleSwitcherPreset( )
public void cycleVolumeMute(com.amx.duet.devicesdk.device.type.Zone zone)
public void finalize( )
public int getBalance(com.amx.duet.devicesdk.device.type.Zone zone)
public int getBass(com.amx.duet.devicesdk.device.type.Zone zone)
public int getGain(com.amx.duet.devicesdk.device.type.Zone zone)
public int getInput(com.amx.duet.devicesdk.device.type.SwitchLevel sl, int output)
public int getInputCount( )
public int[ ] getOutput(com.amx.duet.devicesdk.device.type.SwitchLevel sl, int input)
public int getOutputCount( )
public com.amx.duet.devicesdk.device.type.PowerState getPower( )
public com.amx.duet.devicesdk.device.type.SurroundState getSurroundMode(com.amx.duet.devicesdk.device.type.Zone zone)
public int getSwitcherPreset( )
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public boolean isBreakAwaySupported( )
public boolean isGainMuteOn(com.amx.duet.devicesdk.device.type.Zone zone)
public boolean isLoudnessOn(com.amx.duet.devicesdk.device.type.Zone zone)
public boolean isVolumeMuteOn(com.amx.duet.devicesdk.device.type.Zone zone)
public void nextSurroundMode(com.amx.duet.devicesdk.device.type.Zone zone)
public void nextSwitcherPreset( )
public void previousSurroundMode(com.amx.duet.devicesdk.device.type.Zone zone)
public void previousSwitcherPreset( )
public void saveSwitcherPreset(int preset)
public void setBalance(com.amx.duet.devicesdk.device.type.Zone zone, int balance)
public void setBass(com.amx.duet.devicesdk.device.type.Zone zone, int bass)
public void setGain(com.amx.duet.devicesdk.device.type.Zone zone, int level)
public void setGainMuteOn(com.amx.duet.devicesdk.device.type.Zone zone, boolean state)
public void setLoudnessOn(com.amx.duet.devicesdk.device.type.Zone zone, boolean state)
public void setPower(com.amx.duet.devicesdk.device.type.PowerState ps)
public void setSurroundMode(com.amx.duet.devicesdk.device.type.Zone zone,
com.amx.duet.devicesdk.device.type.SurroundState sm)
public void setSwitcherPreset(int preset)
public void setTreble(com.amx.duet.devicesdk.device.type.Zone zone, int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)
public void switchInputToOutput(com.amx.duet.devicesdk.device.type.SwitchLevel sl, int input, int output)
public void switchInputToOutput(com.amx.duet.devicesdk.device.type.SwitchLevel sl, int input, int[ ] output)
public void switchInputToOutput(com.amx.duet.devicesdk.device.type.SwitchLevel sl, int[ ] input, int[ ] output)

The TV class provides a standard API for communication with and control of television devices. The TV API includes, but is not limited to, the following methods:
public TV( )
public TV(BundleContext bctxt, NetLinxDevice nd, java.util.Properties props)
public void activeWindowEvent(com.amx.duet.devicesdk.feedback.component.DisplayComponentEvent evt)
public void addActiveWindowListener(com.amx.duet.devicesdk.feedback.component.IDisplayComponentListener Istnr)
public void addAspectRatioListener(com.amx.duet.devicesdk.feedback.component.IDisplayComponentListener Istnr)
public void addBalanceListener(com.amx.duet.devicesdk.feedback.component.IPreAmpComponentListener Istnr)
public void addBandListener(com.amx.duet.devicesdk.feedback.component.ITunerStationComponentListener Istnr)
public void addBassListener(com.amx.duet.devicesdk.feedback.component.IPreAmpComponentListener Istnr)
public void addBrightnessListener(com.amx.duet.devicesdk.feedback.component.IDisplayComponentListener Istnr)
public void addColorListener(com.amx.duet.devicesdk.feedback.component.IDisplayComponentListener Istnr)
public void addContrastListener(com.amx.duet.devicesdk.feedback.component.IDisplayComponentListener Istnr)
public void addDataEventListener(com.amx.duet.devicesdk.feedback.IBasicDuetListener Istnr)
public void addFreezeOnListener(com.amx.duet.devicesdk.feedback.component.IDisplayComponentListener Istnr)
public void addInputSourceListener(com.amx.duet.devicesdk.feedback.component.ISourceSelectComponentListener Istnr)
public void addLoudnessOnListener(com.amx.duet.devicesdk.feedback.component.IPreAmpComponentListener Istnr)
public void addPictureMuteOnListener(com.amx.duet.devicesdk.feedback.component.IDisplayComponentListener Istnr)
public void addPowerListener(com.amx.duet.devicesdk.feedback.component.IPowerComponentListener Istnr)
public void addSharpnessListener(com.amx.duet.devicesdk.feedback.component.IDisplayComponentListener Istnr)
public void addStationListener(com.amx.duet.devicesdk.feedback.component.ITunerStationComponentListener Istnr)
public void addStationPresetListener(com.amx.duet.devicesdk.feedback.component.ITunerStationComponentListener Istnr)
public void addSurroundModeListener(com.amx.duet.devicesdk.feedback.component.IPreAmpComponentListener Istnr)
public void addTintListener(com.amx.duet.devicesdk.feedback.component.IDisplayComponentListener Istnr)
public void addTrebleListener(com.amx.duet.devicesdk.feedback.component.IPreAmpComponentListener Istnr)
public void addVideoModeListener(com.amx.duet.devicesdk.feedback.component.IDisplayComponentListener Istnr)
public void addVolumeListener(com.amx.duet.devicesdk.feedback.component.IPreAmpComponentListener Istnr)
public void addVolumeMuteOnListener(com.amx.duet.devicesdk.feedback.component.IPreAmpComponentListener Istnr)
public void addVolumePresetListener(com.amx.duet.devicesdk.feedback.component.IPreAmpComponentListener Istnr)
public void adjustBalance(com.amx.duet.devicesdk.device.type.Zone zone, int offset)
public void adjustBass(com.amx.duet.devicesdk.device.type.Zone zone int offset)
public void adjustBrightness(int offset)
public void adjustColor(int offset)
public void adjustContrast(int offset)
public void adjustSharpness(int offset)
public void adjustTint(int offset)
public void adjustTreble(com.amx.duet.devicesdk.device.type.Zone zone, int offset)
public void adjustVolume(com.amx.duet.devicesdk.device.type.Zone zone, int offset)
public void aspectRatioEvent(com.amx.duet.devicesdk.feedback.component.DisplayComponentEvent evt)
public void balanceEvent(com.amx.duet.devicesdk.feedback.component.PreAmpComponentEvent evt)
public void bandEvent(com.amx.duet.devicesdk.feedback.component.TunerStationComponentEvent evt)
public void bassEvent(com.amx.duet.devicesdk.feedback.component.PreAmpComponentEvent evt)
public void brightnessEvent(com.amx.duet.devicesdk.feedback.component.DisplayComponentEvent evt)
public void colorEvent(com.amx.duet.devicesdk.feedback.component.DisplayComponentEvent evt)
public void contrastEvent(com.amx.duet.devicesdk.feedback.component.DisplayComponentEvent evt)
public void cycleAspectRatio( )
public void cycleBand( )
public void cycleClockDisplay( )
public void cycleDisplayInfo( )
public void cycleFreeze( )
public void cycleInputSource(com.amx.duet.devicesdk.device.type.Zone zone)
public void cycleLoudness(com.amx.duet.devicesdk.device.type.Zone zone)
public void cyclePIP( )
public void cyclePIPPosition( )
public void cyclePictureMute( )
public void cyclePower( )
public void cycleStationPreset( )
public void cycleStationPresetGroup( )
public void cycleSurroundMode(com.amx.duet.devicesdk.device.type.Zone zone)
public void cycleVolumeMute(com.amx.duet.devicesdk.device.type.Zone zone)
public void dataEvent(com.amx.duet.devicesdk.feedback.BasicDuetEvent evt)
public void decrementStation( )
public void finalize( )
public void freezeOnEvent(com.amx.duet.devicesdk.feedback.component.DisplayComponentEvent evt)
public com.amx.duet.devicesdk.device.type.MultiScreenSelect getActiveWindow( )
public com.amx.duet.devicesdk.device.type.AspectRatio getAspectRatio( )
public int getBalance(com.amx.duet.devicesdk.device.type.Zone zone)
public com.amx.duet.devicesdk.device.type.TunerBand getBand( )
public int getBass(com.amx.duet.devicesdk.device.type.Zone zone)
public int getBrightness( )
public int getColor( )
public int getContrast( )
public com.amx.duet.devicesdk.device.type.InputSourceSelect getInputSource(com.amx.duet.devicesdk.device.type.Zone zone)
public com.amx.duet.devicesdk.device.type.PowerState getPower( )
public int getSharpness( )
public java.lang.String getStation( )
public int getStationPreset( )
public com.amx.duet.devicesdk.device.type.SurroundState getSurroundMode(com.amx.duet.devicesdk.device.type.Zone zone)
public com.amx.duet.devicesdk.feedback.TVEventSource getTVEventSource( )
public int getTint( )
public int getTreble(com.amx.duet.devicesdk.device.type.Zone zone)
public com.amx.duet.devicesdk.device.type.VideoState getVideoMode( )
public int getVolume(com.amx.duet.devicesdk.device.type.Zone zone)
public int getVolumePreset(com.amx.duet.devicesdk.device.type.Zone zone)
public void gotoPreviousStation( )
public void incrementStation( )
public void inputSourceEvent(
com.amx.duet.devicesdk.feedback.component.SourceSelectComponentEvent evt)
public boolean isFreezeOn( )
public boolean isLoudnessOn(com.amx.duet.devicesdk.device.type.Zone zone)
public boolean isPIPOn( )
public boolean isPictureMuteOn( )
public boolean isVolumeMuteOn(com.amx.duet.devicesdk.device.type.Zone zone)
public void loudnessOnEvent(com.amx.duet.devicesdk.feedback.component.PreAmpComponentEvent evt)
public void moveMenuCursor(com.amx.duet.devicesdk.device.type.Navigation direction)
public void nextStationPreset( )
public void nextSurroundMode(com.amx.duet.devicesdk.device.type.Zone zone)
public void pictureMuteOnEvent(com.amx.duet.devicesdk.feedback.component.DisplayComponentEvent evt)
public void powerEvent(com.amx.duet.devicesdk.feedback.component.PowerComponentEvent evt)
public void pressMenuButton(com.amx.duet.devicesdk.device.type.Button button)
public void previousStationPreset( )
public void previousSurroundMode(com.amx.duet.devicesdk.device.type.Zone zone)
public void removeActiveWindowListener(com.amx.duet.devicesdk.feedback.component.IDisplayComponentListener Istnr)
public void removeAspectRatioListener(com.amx.duet.devicesdk.feedback.component.IDisplayComponentListener Istnr)
public void removeBalanceListener(com.amx.duet.devicesdk.feedback.component.IPreAmpComponentListener Istnr)
public void removeBandListener(com.amx.duet.devicesdk.feedback.component.ITunerStationComponentListener Istnr)
public void removeBassListener(com.amx.duet.devicesdk.feedback.component.IPreAmpComponentListener Istnr)
public void removeBrightnessListener(com.amx.duet.devicesdk.feedback.component.IDisplayComponentListener Istnr)
public void removeColorListener(com.amx.duet.devicesdk.feedback.component.IDisplayComponentListener Istnr)
public void removeContrastListener(com.amx.duet.devicesdk.feedback.component.IDisplayComponentListener Istnr)
public void removeDataEventListener(com.amx.duet.devicesdk.feedback.IBasicDuetListener Istnr)
public void removeFreezeOnListener(com.amx.duet.devicesdk.feedback.component.IDisplayComponentListener Istnr)
public void removeInputSourceListener(com.amx.duet.devicesdk.feedback.component.ISourceSelectComponentListener Istnr)
public void removeLoudnessOnListener(com.amx.duet.devicesdk.feedback.component.IPreAmpComponentListener Istnr)
public void removePictureMuteOnListener(com.amx.duet.devicesdk.feedback.component.IDisplayComponentListener Istnr)
public void removePowerListener(com.amx.duet.devicesdk.feedback.component.IPowerComponentListener Istnr)
public void removeSharpnessListener(com.amx.duet.devicesdk.feedback.component.IDisplayComponentListener Istnr)
public void removeStationListener(com.amx.duet.devicesdk.feedback.component.ITunerStationComponentListener Istnr)
public void removeStationPresetListener(com.amx.duet.devicesdk.feedback.component.ITunerStationComponentListener Istnr)
public void removeSurroundModeListener(com.amx.duet.devicesdk.feedback.component.IPreAmpComponentListener Istnr)
public void removeTintListener(com.amx.duet.devicesdk.feedback.component.IDisplayComponentListener Istnr)
public void removeTrebleListener(com.amx.duet.devicesdk.feedback.component.IPreAmpComponentListener Istnr)
public void removeVideoModeListener(com.amx.duet.devicesdk.feedback.component.IDisplayComponentListener Istnr)
public void removeVolumeListener(com.amx.duet.devicesdk.feedback.component.IPreAmpComponentListener Istnr)
public void removeVolumeMuteOnListener(com.amx.duet.devicesdk.feedback.component.IPreAmpComponentListener Istnr)
public void removeVolumePresetListener(com.amx.duet.devicesdk.feedback.component.IPreAmpComponentListener Istnr)
public void route(com.amx.duet.devicesdk.system.RouterTypes cRT, java.lang.Object cObj)
public void scanStation(com.amx.duet.devicesdk.device.type.StationSearchCommand sc)
public void seekStation(com.amx.duet.devicesdk.device.type.StationSearchCommand sc)
public void selectMenuItem( )
public void setActiveWindow(com.amx.duet.devicesdk.device.type.MultiScreenSelect mss)
public void setAspectRatio(com.amx.duet.devicesdk.device.type.AspectRatio anAspectRatio)
public void setBalance(com.amx.duet.devicesdk.device.type.Zone zone, int balance)
public void setBand(com.amx.duet.devicesdk.device.type.TunerBand tb)
public void setBass(com.amx.duet.devicesdk.device.type.Zone zone, int bass)
public void setBrightness(int level)
public void setColor(int level)
public void setContrast(int level)
public void setFreezeOn(boolean state)
public void setInputSource(com.amx.duet.devicesdk.device.type.Zone zone, com.amx.duet.devicesdk.device.type.InputSourceSelect sourceSelect)
public void setLoudnessOn(com.amx.duet.devicesdk.device.type.Zone zone, boolean state)
public void setPIPOn(boolean state)
public void setPictureMuteOn(boolean state)
public void setPower(com.amx.duet.devicesdk.device.type.PowerState ps)
public void setSharpness(int level)
public void setStation(java.lang.String station)
public void setStationPreset(int preset)
public void setSurroundMode(com.amx.duet.devicesdk.device.type.Zone zone, com.amx.duet.devicesdk.device.type.SurroundState sm)
public void setTint(int level)
public void setTreble(com.amx.duet.devicesdk.device.type.Zone zone, int treble)
public void setVideoMode(com.amx.duet.devicesdk.device.type.VideoState vm)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)
public void sharpnessEvent(com.amx.duet.devicesdk.feedback.component.DisplayComponentEvent evt)
public void stationEvent(com.amx.duet.devicesdk.feedback.component.TunerStationComponentEvent evt)
public void stationPresetEvent(com.amx.duet.devicesdk.feedback.component.TunerStationComponentEvent evt)
public void surroundModeEvent(com.amx.duet.devicesdk.feedback.component.PreAmpComponentEvent evt)
public void swapPIP( )
public void tintEvent(com.amx.duet.devicesdk.feedback.component.DisplayComponentEvent evt)
public void trebleEvent(com.amx.duet.devicesdk.feedback.component.PreAmpComponentEvent evt)
public void videoModeEvent(com.amx.duet.devicesdk.feedback.component.DisplayComponentEvent evt)
public void volumeEvent(com.amx.duet.devicesdk.feedback.component.PreAmpComponentEvent evt)
public void volumeMuteOnEvent(com.amx.duet.devicesdk.feedback.component.PreAmpComponentEvent evt)
public void volumePresetEvent(com.amx.duet.devicesdk.feedback.component.PreAmpComponentEvent evt)

The VCR class provides a standard API for communication with and control of VCR devices. The VCR API includes, but is not limited to, the following methods:
public VCR( )
public VCR(BundleContext bctxt, NetLinxDevice nd, java.util.Properties props)
public void cycleBand( )
public void cycleDisplayInfo( )
public void cycleInputSource(com.amx.duet.devicesdk.device.type.Zone zone)
public void cyclePower( )
public void cycleSearchSpeed( )
public void cycleStationPreset( )
public void cycleStationPresetGroup( )
public void decrementStation( )
public void ejectTape( )
public void finalize( )
public com.amx.duet.devicesdk.device.type.TunerBand getBand( )
public com.amx.duet.devicesdk.device.type.InputSourceSelect getInputSource(com.amx.duet.devicesdk.device.type.Zone zone)
public com.amx.duet.devicesdk.device.type.PowerState getPower( )
public com.amx.duet.devicesdk.device.type.TapeRecordSpeed getRecordSpeed( )
public com.amx.duet.devicesdk.device.type.SearchSpeed getSearchSpeed( )
public java.lang.String getStation( )
public int getStationPreset( )
public com.amx.duet.devicesdk.device.type.MediaCounter getTapeCounter( )
public com.amx.duet.devicesdk.device.type.TapeTransport getTapeTransport( )
public void gotoPreviousStation( )
public void incrementStation( )
public boolean isRecordLocked( )
public boolean isTapeLoaded( )
public void moveMenuCursor(com.amx.duet.devicesdk.device.type.Navigation direction)
public void nextStationPreset( )
public void pressMenuButton(com.amx.duet.devicesdk.device.type.Button button)
public void previousStationPreset( )
public void resetCounter( )
public void scanStation(com.amx.duet.devicesdk.device.type.StationSearchCommand sc)
public void seekStation(com.amx.duet.devicesdk.device.type.StationSearchCommand sc)
public void selectMenuItem( )
public void setBand(com.amx.duet.devicesdk.device.type.TunerBand tb)
public void setinputSource(com.amx.duet.devicesdk.device.type.Zone zone, com.amx.duet.devicesdk.device.type.InputSourceSelect sourceSelect)
public void setPower(com.amx.duet.devicesdk.device.type.PowerState ps)
public void setRecordSpeed(com.amx.duet.devicesdk.device.type.TapeRecordSpeed trs)
public void setStation(java.lang.String station)
public void setStationPreset(int preset)
public void setTapeTransport(com.amx.duet.devicesdk.device.type.TapeTransport tt)
public void setTapeTransport(com.amx.duet.devicesdk.device.type.TapeTransport tt, com.amx.duet.devicesdk.device.type.SearchSpeed ss)

The VideoConferencer class provides a standard API for communication with and control of video conference devices. The VideoConferencer API includes, but is not limited to, the following methods:
public VideoConferencer( )
public VideoConferencer(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustBrightness(int offset)
public void adjustColor(int offset)
public void adjustContrast(int offset)
public void adjustSharpness(int offset)
public void adjustTint(int offset)
public void adjustTreble(com.amx.duet.devicesdk.device.type.Zone zone, int offset)
public void adjustVolume(com.amx.duet.devicesdk.device.type.Zone zone, int offset)
public void captureGraphic(int call)
public void cycleAspectRatio( )
public void cycleAudibleRing(com.amx.duet.devicesdk.device.type.Controller ctrller)
public void cycleAutoAnswer(com.amx.duet.devicesdk.device.type.Controller ctrller)
public void cycleAutoFocus( )
public void cycleAutoIris( )
public void cycleClockDisplay( )
public void cycleFreeze( )
public void cycleInputSource(com.amx.duet.devicesdk.device.type.Zone zone)
public void cycleLoudness(com.amx.duet.devicesdk.device.type.Zone zone)
public void cycleOffHook(com.amx.duet.devicesdk.device.type.Controller ctrller)
public void cyclePIP( )
public void cyclePIPPosition( )
public void cyclePictureMute( )
public void cyclePower( )
public void cyclePrivacy( )
public void cycleSurroundMode(com.amx.duet.devicesdk.device.type.Zone zone)
public void cycleVolumeMute(com.amx.duet.devicesdk.device.type.Zone zone)
public void dialNumber(com.amx.duet.devicesdk.device.type.Controller ctrller, com.amx.duet.devicesdk.device.type.SpeedDialEntry pbe)
public void dialNumber(com.amx.duet.devicesdk.device.type.Controller ctrller, java.lang.String number)
public void finalize( )
public void flash(com.amx.duet.devicesdk.device.type.Controller ctrller)
public com.amx.duet.devicesdk.device.type.MultiScreenSelect getActiveWindow( )
public com.amx.duet.devicesdk.device.type.AspectRatio getAspectRatio( )
public com.amx.duet.devicesdk.device.component.IDialerComponent getAudioDialer(int index)
public int getBalance(com.amx.duet.devicesdk.device.type.Zone zone)
public int getBass(com.amx.duet.devicesdk.device.type.Zone zone)
public int getBrightness( )
public java.lang.String getCallerID(com.amx.duet.devicesdk.device.type.Controller ctrller)
public int getColor( )
public int getContrast( )
public com.amx.duet.devicesdk.device.type.DialerState getDialerState(com.amx.duet.devicesdk.device.type.Controller ctrller)
public com.amx.duet.devicesdk.device.lCamera getFarEndCamera(int index)
public int getFocus( )
public int getFocusSpeed( )
public com.amx.duet.devicesdk.device.component.ISourceSelectComponent getGraphicSourceSelect(int call)
public com.amx.duet.devicesdk.device.type.InputSourceSelect getInputSource(com.amx.duet.devicesdk.device.type.Zone zone)
public int getIris( )
public int getIrisSpeed( )
public java.lang.String getLastNumberDialed(com.amx.duet.devicesdk.device.type.Controller ctrller)
public com.amx.duet.devicesdk.device.ICamera getNearEndCamera(int index)
public int getPan( )
public int getPanSpeed( )
public com.amx.duet.devicesdk.device.type.PowerState getPower( )
public com.amx.duet.devicesdk.device.component.ISourceSelectComponent getPreviewSourceSelect( )
public com.amx.duet.devicesdk.device.type.RampFocus getRampFocus( )
public com.amx.duet.devicesdk.device.type.RampIris getRampIris( )
public com.amx.duet.devicesdk.device.type.RampPan getRampPan( )
public com.amx.duet.devicesdk.device.type.RampTilt getRampTilt( )
public com.amx.duet.devicesdk.device.type.RampZoom getRampZoom( )
public int getSharpness( )
public com.amx.duet.devicesdk.device.ISpeedDialDB getSpeedDialDB( )
public com.amx.duet.devicesdk.device.type.SurroundState getSurroundMode(com.amx.duet.devicesdk.device.type.Zone zone)
public int getTilt( )
public int getTiltSpeed( )
public int getTint( )
public int getTreble(com.amx.duet.devicesdk.device.type.Zone zone)
public com.amx.duet.devicesdk.device.component.IDialerComponent getVideoDialer(int index)
public com.amx.duet.devicesdk.device.type.VideoState getVideoMode( )
public int getVolume(com.amx.duet.devicesdk.device.type.Zone zone)
public int getVolumePreset(com.amx.duet.devicesdk.device.type.Zone zone)
public int getZoom( )
public int getZoomSpeed( )
public boolean isAudibleRingOn(com.amx.duet.devicesdk.device.type.Controller ctrller)
public boolean isAutoAnswerOn(com.amx.duet.devicesdk.device.type.Controller ctrller)
public boolean isAutoFocusOn( )
public boolean isAutoIrisOn( )
public boolean isFreezeOn( )
public boolean isLoudnessOn(com.amx.duet.devicesdk.device.type.Zone zone)
public boolean isOffHook(com.amx.duet.devicesdk.device.type.Controller ctrller)
public boolean isPIPOn( )
public boolean isPictureMuteOn( )
public boolean isPrivacyOn( )
public boolean isVolumeMuteOn(com.amx.duet.devicesdk.device.type.Zone zone)
public void moveMenuCursor(com.amx.duet.devicesdk.device.type.Navigation direction)
public void nextSurroundMode(com.amx.duet.devicesdk.device.type.Zone zone)
public void pressMenuButton(com.amx.duet.devicesdk.device.type.Button button)
public void previousSurroundMode(com.amx.duet.devicesdk.device.type.Zone zone)
public void redialNumber(com.amx.duet.devicesdk.device.type.Controller ctrller)
public void selectMenuItem( )
public void sendGraphic(int call)
public void setActiveWindow(com.amx.duet.devicesdk.device.type.MultiScreenSelect mss)
public void setAspectRatio(com.amx.duet.devicesdk.device.type.AspectRatio anAspectRatio)
public void setAudibleRingOn(com.amx.duet.devicesdk.device.type.Controller ctrller, boolean state)
public void setAutoAnswerOn(com.amx.duet.devicesdk.device.type.Controller ctrller, boolean state)
public void setAutoFocusOn(boolean state)
public void setAutoIrisOn(boolean state)
public void setBalance(com.amx.duet.devicesdk.device.type.Zone zone, int balance)
public void setBass(com.amx.duet.devicesdk.device.type.Zone zone, int bass)
public void setBrightness(int level)
public void setColor(int level)
public void setContrast(int level)
public void setFocus(int focus)
public void setFocusSpeed(int speed)
public void setFreezeOn(boolean state)
public void setInputSource(com.amx.duet.devicesdk.device.type.Zone zone, com.amx.duet.devicesdk.device.type.InputSourceSelect sourceSelect)
public void setIris(int iris)
public void setIrisSpeed(int speed)
public void setLoudnessOn(com.amx.duet.devicesdk.device.type.Zone zone, boolean state)
public void setOffHook(com.amx.duet.devicesdk.device.type.Controller ctrller, boolean state)
public void setPIPOn(boolean state)
public void setPan(int pan)
public void setPanSpeed(int speed)
public void setPictureMuteOn(boolean state)
public void setPower(com.amx.duet.devicesdk.device.type.PowerState ps)
public void setPrivacyOn(boolean state)
public void setRampFocus(com.amx.duet.devicesdk.device.type.RampFocus rf)
public void setRampIris(com.amx.duet.devicesdk.device.type.RampIris ri)
public void setRampPan(com.amx.duet.devicesdk.device.type.RampPan rp)
public void setRampPanTilt(com.amx.duet.devicesdk.device.type.RampPan rp, com.amx.duet.devicesdk.device.type.RampTilt rt)
public void setRampTilt(com.amx.duet.devicesdk.device.type.RampTilt rt)
public void setRampZoom(com.amx.duet.devicesdk.device.type.RampZoom rz)
public void setSharpness(int level)
public void setSurroundMode(com.amx.duet.devicesdk.device.type.Zone zone, com.amx.duet.devicesdk.device.type.SurroundState sm)
public void setTilt(int tilt)
public void setTiltSpeed(int speed)
public void setTint(int level)
public void setTreble(com.amx.duet.devicesdk.device.type.Zone zone, int treble)
public void setVideoMode(com.amx.duet.devicesdk.device.type.VideoState vm)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone. int preset)
public void setZoom(int zoom)
public void setZoomSpeed(int speed)
public void swapPIP( )

The VideoProjector class provides a standard API for communication with and control of video projector devices. The VideoProjector API includes, but is not limited to, the following methods:
public VideoProjector( )
public VideoProjector(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustBrightness(int offset)
public void adjustColor(int offset)
public void adjustContrast(int offset)
public void adjustSharpness(int offset)
public void adjustTint(int offset)
public void adjustTreble(com.amx.duet.devicesdk.device.type.Zone zone, int offset)
public void adjustVolume(com.amx.duet.devicesdk.device.type.Zone zone, int offset)
public void cycleAspectRatio( )
public void cycleClockDisplay( )
public void cycleFreeze( )
public void cycleInputSource(com.amx.duet.devicesdk.device.type.Zone zone)
public void cycleLoudness(com.amx.duet.devicesdk.device.type.Zone zone)
public void cyclePIP( )
public void cyclePIPPosition( )
public void cyclePictureMute( )
public void cyclePower( )
public void cycleProjectorPreset( )
public void cycleSurroundMode(com.amx.duet.devicesdk.device.type.Zone zone)
public void cycleVolumeMute(com.amx.duet.devicesdk.device.type.Zone zone)
public void finalize( )
public com.amx.duet.devicesdk.device.type.MultiScreenSelect getActiveWindow( )
public com.amx.duet.devicesdk.device.type.AspectRatio getAspectRatio( )
public int getBalance(com.amx.duet.devicesdk.device.type.Zone zone)
public int getBass(com.amx.duet.devicesdk.device.type.Zone zone)
public int getBrightness( )
public int getColor( )
public int getContrast( )
public int getCoolDownCounter( )
public int getCoolDownTime( )
public com.amx.duet.devicesdk.device.type.InputSourceSelect getInputSource(com.amx.duet.devicesdk.device.type.Zone zone)
public int getLampTime( )
public com.amx.duet.devicesdk.device.type.PowerState getPower( )
public int getProjectorPreset( )
public int getSharpness( )
public com.amx.duet.devicesdk.device.type.SurroundState getSurroundMode(com.amx.duet.devicesdk.device.type.Zone zone)
public int getTint( )
public int getTreble(com.amx.duet.devicesdk.device.type.Zone zone)
public com.amx.duet.devicesdk.device.type.VideoState getVideoMode( )
public int getVolume(com.amx.duet.devicesdk.device.type.Zone zone)
public int getVolumePreset(com.amx.duet.devicesdk.device.type.Zone zone)
public int getWarmUpCounter( )
public int getWarmUpTime( )
public boolean isFreezeOn( )
public boolean isLoudnessOn(com.amx.duet.devicesdk.device.type.Zone zone)
public boolean isPIPOn( )
public boolean isPictureMuteOn( )
public boolean isVolumeMuteOn(com.amx.duet.devicesdk.device.type.Zone zone)
public boolean isWarmUpCoolDownOn( )
public void moveMenuCursor(com.amx.duet.devicesdk.device.type.Navigation direction)
public void nextProjectorPreset( )
public void nextSurroundMode(com.amx.duet.devicesdk.device.type.Zone zone)
public void pressMenuButton(com.amx.duet.devicesdk.device.type.Button button)
public void previousProjectorPreset( )
public void previousSurroundMode(com.amx.duet.devicesdk.device.type.Zone zone)
public void selectMenuItem( )
public void setActiveWindow(com.amx.duet.devicesdk.device.type.MultiScreenSelect mss)
public void setAspectRatio(com.amx.duet.devicesdk.device.type.AspectRatio anAspectRatio)
public void setBalance(com.amx.duet.devicesdk.device.type.Zone zone, int balance)
public void setBass(com.amx.duet.devicesdk.device.type.Zone zone, int bass)
public void setBrightness(int level)
public void setColor(int level)
public void setContrast(int level)
public void setCoolDownTime(int time)
public void setFreezeOn(boolean state)
public void setInputSource(com.amx.duet.devicesdk.device.type.Zone zone, com.amx.duet.devicesdk.device.type.InputSourceSelect sourceSelect)
public void setLampTime(int hours)
public void setLoudnessOn(com.amx.duet.devicesdk.device.type.Zone zone, boolean state)
public void setPIPOn(boolean state)
public void setPictureMuteOn(boolean state)
public void setPower(com.amx.duet.devicesdk.device.type.PowerState ps)
public void setProjectorPreset(int preset)
public void setSharpness(int level)
public void setSurroundMode(com.amx.duet.devicesdk.device.type.Zone zone, com.amx.duet.devicesdk.device.type.SurroundState sm)
public void setTint(int level)
public void setTreble(com.amx.duet.devicesdk.device.type.Zone zone, int treble)
public void setVideoMode(com.amx.duet.devicesdk.device.type.VideoState vm)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)
public void setWarmUpCoolDownOn(boolean state)
public void setWarmUpTime(int time)
public void swapPIP( )

The VolumeController class provides a standard API for communication with and control of volume control devices. The VolumeController API includes, but is not limited to, the following methods:
public VolumeController( )
public VolumeController(BundleContext bctxt, NetLinxDevice nd, java.util.Properties props)
public void adjustBalance(com.amx.duet.devicesdk.device.type.Zone zone, int offset)
public void adjustBass(com.amx.duet.devicesdk.device.type.Zone zone, int offset)
public void adjustTreble(com.amx.duet.devicesdk.device.type.Zone zone, int offset)
public void adjustVolume(com.amx.duet.devicesdk.device.type.Zone zone, int offset)
public void cycleLoudness(com.amx.duet.devicesdk.device.type.Zone zone)
public void cycleSurroundMode(com.amx.duet.devicesdk.device.type.Zone zone)
public void cycleVolumeMute(com.amx.duet.devicesdk.device.type.Zone zone)
public void finalize( )
public int getBalance(com.amx.duet.devicesdk.device.type.Zone zone)
public int getBass(com.amx.duet.devicesdk.device.type.Zone zone)
public com.amx.duet.devicesdk.device.type.SurroundState getSurroundMode(com.amx.duet.devicesdk.device.type.Zone zone)
public int getTreble(com.amx.duet.devicesdk.device.type.Zone zone)
public int getVolume(com.amx.duet.devicesdk.device.type.Zone zone)
public int getVolumePreset(com.amx.duet.devicesdk.device.type.Zone zone)
public boolean isLoudnessOn(com.amx.duet.devicesdk.device.type.Zone zone)
public boolean isVolumeMuteOn(com.amx.duet.devicesdk.device.type.Zone zone)
public void nextSurroundMode(com.amx.duet.devicesdk.device.type.Zone zone)
public void previousSurroundMode(com.amx.duet.devicesdk.device.type.Zone zone)
public void setBalance(com.amx.duet.devicesdk.device.type.Zone zone, int balance)
public void setBass(com.amx.duet.devicesdk.device.type.Zone zone, int bass)
public void setLoudnessOn(com.amx.duet.devicesdk.device.type.Zone zone, boolean state)
public void setSurroundMode(com.amx.duet.devicesdk.device.type.Zone zone, com.amx.duet.devicesdk.device.type.SurroundState sm)
public void setTreble(com.amx.duet.devicesdk.device.type.Zone zone, int treble)
public void setVolume(com.amx.duet.devicesdk.device.type.Zone zone, int level)
public void setVolumeMuteOn(com.amx.duet.devicesdk.device.type.Zone zone, boolean state)
public void setVolumePreset(com.amx.duet.devicesdk.device.type.Zone zone, int preset)

The Weather class provides a standard API for communication with and control of weather devices. The Weather API includes, but is not limited to, the following methods:
public Weather( )
public Weather(BundleContext bctxt, NetLinxDevice nd, java.util.Properties props)
public void chanceOfPrecipitation( )
public void conditions( )
public void displayBarometricPressure( )
public void displayBarometricTrend( )
public void displayDewpoint( )
public void displayIndoorsHumidity( )
public void displayInsideTemperature( )
public void displayOutdoorsHumidity( )
public void displayOutsideTemperature( )
public void displayRainFall( )
public void displayTemperatureHumidityIndex( )
public void displayWindDirection( )
public void displayWindSpeed( )
public void displayWindchillFactor( )
public void finalize( )
public void highTemperature( )
public void lowTemperature( )
public void sample₁₃ ForceNewReadings( )
public void scaleCelsiusOrFahrenheit( )
public void scalePressure( )
public void scaleRainFall( )
public void scaleWindSpeed( )

The standard API of the present invention utilizes various Java classes including, but not limited to, the following:
Class AspectRatio
public static final com.amx.duet.devicesdk.device.type.AspectRatio ANAMORPHIC
public static final com.amx.duet.devicesdk.device.type.AspectRatio FOUR_BY_THREE
public static final com.amx.duet.devicesdk.device.type.AspectRatio INVALID
public static final com.amx.duet.devicesdk.device.type.AspectRatio NORMAL
public static final com.amx.duet.devicesdk.device.type.AspectRatio SIXTEEN_BY_NINE
public static final com.amx.duet.devicesdk.device.type.AspectRatio TWENTYONE_BY_NINE
public static final com.amx.duet.devicesdk.device.type.AspectRatio WIDE
public final boolean equals(java.lang.Object obj)
public final int hashCode( )
public java.lang.String toString( )
Class AudioChannelConfigs
public static final com.amx.duet.devicesdk.device.type.AudioChannelConfigs FIVE_CHANNEL
public static final com.amx.duet.devicesdk.device.type.AudioChannelConfigs FIVE_DOT_ONE_CHANNEL
public static final com.amx.duet.devicesdk.device.type.AudioChannelConfigs FOUR_CHANNEL
public static final com.amx.duet.devicesdk.device.type.AudioChannelConfigs FOUR_DOT_ONE_CHANNEL
public static final com.amx.duet.devicesdk.device.type.AudioChannelConfigs INVALID
public static final com.amx.duet.devicesdk.device.type.AudioChannelConfigs LEFT_AND_RIGHT_CHANNELS
public static final com.amx.duet.devicesdk.device.type.AudioChannelConfigs LEFT_CHANNEL
public static final com.amx.duet.devicesdk.device.type.AudioChannelConfigs ONE_CHANNEL
public static final com.amx.duet.devicesdk.device.type.AudioChannelConfigs RIGHT_CHANNEL
public static final com.amx.duet.devicesdk.device.type.AudioChannelConfigs SIX_CHANNEL
public static final com.amx.duet.devicesdk.device.type.AudioChannelConfigs THREE_CHANNEL
public static final com.amx.duet.devicesdk.device.type.AudioChannelConfigs THREE_DOT_ONE_CHANNEL
public static final com.amx.duet.devicesdk.device.type.AudioChannelConfigs TWO_CHANNEL
public static final com.amx.duet.devicesdk.device.type.AudioChannelConfigs TWO_DOT_ONE_CHANNEL
public static final com.amx.duet.devicesdk.device.type.AudioChannelConfigs UNKNOWN
public final boolean equals(java.lang.Object obj)
public final int hashCode( )
public java.lang.String toString( )
Class Button
public static final com.amx.duet.devicesdk.device.type.Button A
public static final com.amx.duet.devicesdk.device.type.Button AB_REPEAT
public static final com.amx.duet.devicesdk.device.type.Button ADVANCE
public static final com.amx.duet.devicesdk.device.type.Button ANGLE
public static final com.amx.duet.devicesdk.device.type.Button ASTERISK
public static final com.amx.duet.devicesdk.device.type.Button AUDIO
public static final com.amx.duet.devicesdk.device.type.Button B
public static final com.amx.duet.devicesdk.device.type.Button BACK
public static final com.amx.duet.devicesdk.device.type.Button C
public static final com.amx.duet.devicesdk.device.type.Button CANCEL
public static final com.amx.duet.devicesdk.device.type.Button CLEAR
public static final com.amx.duet.devicesdk.device.type.Button COMMA
public static final com.amx.duet.devicesdk.device.type.Button D
public static final com.amx.duet.devicesdk.device.type.Button DASH
public static final com.amx.duet.devicesdk.device.type.Button DIGIT_{—}0
public static final com.amx.duet.devicesdk.device.type.Button DIGIT_{—}1
public static final com.amx.duet.devicesdk.device.type.Button DIGIT_{—}2
public static final com.amx.duet.devicesdk.device.type.Button DIGIT_{—}3
public static final com.amx.duet.devicesdk.device.type.Button DIGIT_{—}4
public static final com.amx.duet.devicesdk.device.type.Button DIGIT_{—}5
public static final com.amx.duet.devicesdk.device.type.Button DIGIT_{—}6
public static final com.amx.duet.devicesdk.device.type.Button DIGIT_{—}7
public static final com.amx.duet.devicesdk.device.type.Button DIGIT_{—}8
public static final com.amx.duet.devicesdk.device.type.Button DIGIT_{—}9
public static final com.amx.duet.devicesdk.device.type.Button DIMMER
public static final com.amx.duet.devicesdk.device.type.Button DISPLAY
public static final com.amx.duet.devicesdk.device.type.Button DOT
public static final com.amx.duet.devicesdk.device.type.Button DOWN_ARROW
public static final com.amx.duet.devicesdk.device.type.Button E
public static final com.amx.duet.devicesdk.device.type.Button ENTER
public static final com.amx.duet.devicesdk.device.type.Button EXIT
public static final com.amx.duet.devicesdk.device.type.Button F
public static final com.amx.duet.devicesdk.device.type.Button FAVORITES
public static final com.amx.duet.devicesdk.device.type.Button FLASH
public static final com.amx.duet.devicesdk.device.type.Button FORWARD
public static final com.amx.duet.devicesdk.device.type.Button G
public static final com.amx.duet.devicesdk.device.type.Button GUIDE
public static final com.amx.duet.devicesdk.device.type.Button H
public static final com.amx.duet.devicesdk.device.type.Button HELP
public static final com.amx.duet.devicesdk.device.type.Button HOLD
public static final com.amx.duet.devicesdk.device.type.Button I
public static final com.amx.duet.devicesdk.device.type.Button INFO
public static final com.amx.duet.devicesdk.device.type.Button INSTANT_REPLAY
public static final com.amx.duet.devicesdk.device.type.Button INVALID
public static final com.amx.duet.devicesdk.device.type.Button J
public static final com.amx.duet.devicesdk.device.type.Button K
public static final com.amx.duet.devicesdk.device.type.Button L
public static final com.amx.duet.devicesdk.device.type.Button LEFT_ARROW
public static final com.amx.duet.devicesdk.device.type.Button LEFT_PAREN
public static final com.amx.duet.devicesdk.device.type.Button LIST
public static final com.amx.duet.devicesdk.device.type.Button LIVE_TV
public static final com.amx.duet.devicesdk.device.type.Button M
public static final com.amx.duet.devicesdk.device.type.Button MENU
public static final com.amx.duet.devicesdk.device.type.Button N
public static final com.amx.duet.devicesdk.device.type.Button O
public static final com.amx.duet.devicesdk.device.type.Button P
public static final com.amx.duet.devicesdk.device.type.Button PLUS_{—}10
public static final com.amx.duet.devicesdk.device.type.Button PLUS_{—}100
public static final com.amx.duet.devicesdk.device.type.Button PLUS_{—}1000
public static final com.amx.duet.devicesdk.device.type.Button POUND
public static final com.amx.duet.devicesdk.device.type.Button PROGRAM
public static final com.amx.duet.devicesdk.device.type.Button Q
public static final com.amx.duet.devicesdk.device.type.Button R
public static final com.amx.duet.devicesdk.device.type.Button RESET
public static final com.amx.duet.devicesdk.device.type.Button RETURN
public static final com.amx.duet.devicesdk.device.type.Button RIGHT_ARROW
public static final com.amx.duet.devicesdk.device.type.Button RIGHT_PAREN
public static final com.amx.duet.devicesdk.device.type.Button S
public static final com.amx.duet.devicesdk.device.type.Button SUBTITLE
public static final com.amx.duet.devicesdk.device.type.Button T
public static final com.amx.duet.devicesdk.device.type.Button THUMBS_DOWN
public static final com.amx.duet.devicesdk.device.type.Button THUMBS_UP
public static final com.amx.duet.devicesdk.device.type.Button TITLE
public static final com.amx.duet.devicesdk.device.type.Button TOP_MENU
public static final com.amx.duet.devicesdk.device.type.Button TV_VCR
public static final com.amx.duet.devicesdk.device.type.Button U
public static final com.amx.duet.devicesdk.device.type.Button UNDER_SCORE
public static final com.amx.duet.devicesdk.device.type.Button UP_ARROW
public static final com.amx.duet.devicesdk.device.type.Button V
public static final com.amx.duet.devicesdk.device.type.Button W
public static final com.amx.duet.devicesdk.device.type.Button X
public static final com.amx.duet.devicesdk.device.type.Button Y
public static final com.amx.duet.devicesdk.device.type.Button Z
public static final com.amx.duet.devicesdk.device.type.Button ZOOM
public final boolean equals(java.lang.Object obj)
public final int hashCode( )
public java.lang.String toString( )
Class ButtonAddress
public static final com.amx.duet.devicesdk.device.type.ButtonAddress ALL_BUTTONS
public static final com.amx.duet.devicesdk.device.type.ButtonAddress NO_BUTTONS
public ButtonAddress(int buttonAddress)
public ButtonAddress(java.lang.String buttonAddress)
public boolean equals(java.lang.Object obj)
public java.lang.String getButtonAddress( )
public int hashCode( )
public java.lang.String toString( )
public static com.amx.duet.devicesdk.device.type.ButtonAddress toValue(int buttonAddress)
public static com.amx.duet.devicesdk.device.type.ButtonAddress toValue(java.lang.String buttonAddress)
Class ButtonState
public static final com.amx.duet.devicesdk.device.type.ButtonState CLICK
public static final com.amx.duet.devicesdk.device.type.ButtonState DOUBLE_CLICK
public static final com.amx.duet.devicesdk.device.type.ButtonState INVALID
public static final com.amx.duet.devicesdk.device.type.ButtonState PUSH
public static final com.amx.duet.devicesdk.device.type.ButtonState RELEASE
public final boolean equals(java.lang.Object obj)
public final int hashCode( )
public java.lang.String toString( )
Class ButtonStatus
public static final com.amx.duet.devicesdk.device.type.ButtonStatus BLINK
public static final com.amx.duet.devicesdk.device.type.ButtonStatus INVALID
public static final com.amx.duet.devicesdk.device.type.ButtonStatus OFF
public static final com.amx.duet.devicesdk.device.type.ButtonStatus ON
public final boolean equals(java.lang.Object obj)
public final int hashCode( )
public java.lang.String toString( )
Class Controller
public static final com.amx.duet.devicesdk.device.type.Controller ALL_CONTROLLERS
public static final com.amx.duet.devicesdk.device.type.Controller NO_CONTROLLER
public Controller(int controllerID)
public Controller(java.lang.String controllerID)
public boolean equals(java.lang.Object obj)
public java.lang.String getControllerID( )
public int hashCode( )
public java.lang.String toString( )
public static com.amx.duet.devicesdk.device.type.Controller toValue(int controllerID)
public static com.amx.duet.devicesdk.device.type.Controller toValue(java.lang.String controllerID)
Class DateTimeFormat
public static final java.text.SimpleDateFormat DAY_IN_WEEK
public static final java.text.SimpleDateFormat DD_MM
public static final java.text.SimpleDateFormat DD_MM_YYYY
public static final java.text.SimpleDateFormat DD_MONTH_YYYY
public static final java.text.SimpleDateFormat H24_MM
public static final java.text.SimpleDateFormat HH24_MM_SS
public static final java.text.SimpleDateFormat HH_MM_SS
public static final java.text.SimpleDateFormat HH_MM_SS_AMPM
public static final java.text.SimpleDateFormat H_MM
public static final java.text.SimpleDateFormat H_MM_AMPM
public static final java.text.SimpleDateFormat MM_DD
public static final java.text.SimpleDateFormat MM_DD_YYYY
public static final java.text.SimpleDateFormat MONTH_DD_YYYY
public static final java.text.SimpleDateFormat YYYY_MM_DD
public DateTimeFormat( )
Class DebugState
public static final com.amx.duet.devicesdk.device.type.DebugState INVALID
public static final com.amx.duet.devicesdk.device.type.DebugState OFF
public static final com.amx.duet.devicesdk.device.type.DebugState ON
public java.lang.String toString( )
Class DialerState
public static final com.amx.duet.devicesdk.device.type.DialerState BUSY
public static final com.amx.duet.devicesdk.device.type.DialerState CONNECTED
public static final com.amx.duet.devicesdk.device.type.DialerState DIALING
public static final com.amx.duet.devicesdk.device.type.DialerState DISCONNECTED
public static final com.amx.duet.devicesdk.device.type.DialerState FAULT
public static final com.amx.duet.devicesdk.device.type.DialerState INCOMING_CALL
public static final com.amx.duet.devicesdk.device.type.DialerState INVALID
public static final com.amx.duet.devicesdk.device.type.DialerState NEGOTIATING
public static final com.amx.duet.devicesdk.device.type.DialerState RINGING
public final boolean equals(java.lang.Object obj)
public final int hashCode( )
public java.lang.String toString( )
Class Direction
public static final com.amx.duet.devicesdk.device.type.Direction FORWARD
public static final com.amx.duet.devicesdk.device.type.Direction INVALID
public static final com.amx.duet.devicesdk.device.type.Direction REVERSE
public final boolean equals(java.lang.Object obj)
public final int hashCode( )
public java.lang.String toString( )
Class DiscInf( )
public DiscInfo( )
public DiscInfo(com.amx.duet.devicesdk.device.type.DiscInfo discInfo)
public DiscInfo(int discSlotNumber, java.lang.String discDBID, com.amx.duet.devicesdk.device.type.Time duration, com.amx.duet.devicesdk.device.type.DiscType dt, int totalTracks, int totalTitles)
public boolean equals(java.lang.Object obj)
public java.lang.String getDiscDBID( ) p1 public int getDiscSlotNumber( )
public com.amx.duet.devicesdk.device.type.DiscType getDiscType( )
public com.amx.duet.devicesdk.device.type.Time getDuration( )
public int getTotalTitles( )
public int getTotalTracks( )
public int hashCode( )
public void setDiscDBID(java.lang.String discDBID)
public void setDiscSlotNumber(int discSlotNumber)
public void setDiscType(com.amx.duet.devicesdk.device.type.DiscType dt)
public void setDuration(com.amx.duet.devicesdk.device.type.Time duration)
public void setTotalTitles(int totalTitles)
public void setTotalTracks(int totalTracks)
public java.lang.String toString( )
Class DiscTransport
public static final com.amx.duet.devicesdk.device.type.DiscTransport INVALID
public static final com.amx.duet.devicesdk.device.type.DiscTransport NEXT
public static final com.amx.duet.devicesdk.device.type.DiscTransport PAUSE
public static final com.amx.duet.devicesdk.device.type.DiscTransport PLAY
public static final com.amx.duet.devicesdk.device.type.DiscTransport PREVIOUS
public static final com.amx.duet.devicesdk.device.type.DiscTransport RECORD
public static final com.amx.duet.devicesdk.device.type.DiscTransport RECORD_PAUSE
public static final com.amx.duet.devicesdk.device.type.DiscTransport SCAN_FWD
public static final com.amx.duet.devicesdk.device.type.DiscTransport SCAN_REV
public static final com.amx.duet.devicesdk.device.type.DiscTransport STOP
public static final com.amx.duet.devicesdk.device.type.DiscTransport UNKNOWN
public final boolean equals(java.lang.Object obj)
public final int hashCode( )
public java.lang.String toString( )
Class DiscType
public static final com.amx.duet.devicesdk.device.type.DiscType CD
public static final com.amx.duet.devicesdk.device.type.DiscType DVD
public static final com.amx.duet.devicesdk.device.type.DiscType INVALID
public static final com.amx.duet.devicesdk.device.type.DiscType LASER_DISC
public final boolean equals(java.lang.Object obj)
public final int hashCode( )
public java.lang.String toString( )
Class FanState
public static final com.amx.duet.devicesdk.device.type.FanState AUTO
public static final com.amx.duet.devicesdk.device.type.FanState INVALID
public static final com.amx.duet.devicesdk.device.type.FanState ON
public final boolean equals(java.lang.Object obj)
public final int hashCode( )
public java.lang.String toString( )
Class HVACState
public static final com.amx.duet.devicesdk.device.type.HVACState AUTO
public static final com.amx.duet.devicesdk.device.type.HVACState COOL
public static final com.amx.duet.devicesdk.device.type.HVACState EMERGENCY_HEAT
public static final com.amx.duet.devicesdk.device.type.HVACState HEAT
public static final com.amx.duet.devicesdk.device.type.HVACState INVALID
public static final com.amx.duet.devicesdk.device.type.HVACState OFF
public final boolean equals(java.lang.Object obj)
public final int hashCode( )
public java.lang.String toString( )
Class HVACStatus
public static final com.amx.duet.devicesdk.device.type.HVACStatus COOL
public static final com.amx.duet.devicesdk.device.type.HVACStatus COOL_{—}2
public static final com.amx.duet.devicesdk.device.type.HVACStatus EMERGENCY_HEAT
public static final com.amx.duet.devicesdk.device.type.HVACStatus HEAT
public static final com.amx.duet.devicesdk.device.type.HVACStatus INVALID
public static final com.amx.duet.devicesdk.device.type.HVACStatus OFF
public final boolean equals(java.lang.Object obj)
public final int hashCode( )
public java.lang.String toString( )
Class HumidifyState
public static final com.amx.duet.devicesdk.device.type.HumidifyState AUTO
public static final com.amx.duet.devicesdk.device.type.HumidifyState DEHUMIDIFY
public static final com.amx.duet.devicesdk.device.type.HumidifyState HUMIDIFY
public static final com.amx.duet.devicesdk.device.type.HumidifyState INVALID
public static final com.amx.duet.devicesdk.device.type.HumidifyState OFF
public final boolean equals(java.lang.Object obj)
public final int hashCode( )
public java.lang.String toString( )
Class HumidifyStatus
public static final com.amx.duet.devicesdk.device.type.HumidifyStatus DEHUMIDIFY
public static final com.amx.duet.devicesdk.device.type.HumidifyStatus HUMIDIFY
public static final com.amx.duet.devicesdk.device.type.HumidifyStatus IDLE
public static final com.amx.duet.devicesdk.device.type.HumidifyStatus INVALID
public final boolean equals(java.lang.Object obj)
public final int hashCode( )
public java.lang.String toString( )
Class IODirection
public static final com.amx.duet.devicesdk.device.type.IODirection INPUT
public static final com.amx.duet.devicesdk.device.type.IODirection INVALID
public static final com.amx.duet.devicesdk.device.type.IODirection OUTPUT
public static final com.amx.duet.devicesdk.device.type.IODirection UNKNOWN
public final boolean equals(java.lang.Object obj)
public final int hashCode( )
public java.lang.String toString( )
Class InputSourceSelect
public static final com.amx.duet.devicesdk.device.type.InputSourceSelect AUXILIARY1
public static final com.amx.duet.devicesdk.device.type.InputSourceSelect AUXILIARY2
public static final com.amx.duet.devicesdk.device.type.InputSourceSelect CABLE
public static final com.amx.duet.devicesdk.device.type.InputSourceSelect CAMERA
public static final com.amx.duet.devicesdk.device.type.InputSourceSelect CD
public static final com.amx.duet.devicesdk.device.type.InputSourceSelect COMPONENT1
public static final com.amx.duet.devicesdk.device.type.InputSourceSelect COMPONENT10
public static final com.amx.duet.devicesdk.device.type.InputSourceSelect COMPONENT2
public static final com.amx.duet.devicesdk.device.type.InputSourceSelect COMPONENT3
public static final com.amx.duet.devicesdk.device.type.InputSourceSelect COMPONENT4
public static final com.amx.duet.devicesdk.device.type.InputSourceSelect COMPONENT5
public static final com.amx.duet.devicesdk.device.type.InputSourceSelect COMPONENT6
public static final com.amx.duet.devicesdk.device.type.InputSourceSelect COMPONENT7
public static final com.amx.duet.devicesdk.device.type.InputSourceSelect COMPONENT8
public static final com.amx.duet.devicesdk.device.type.InputSourceSelect COMPONENT9
public static final com.amx.duet.devicesdk.device.type.InputSourceSelect COMPOSITE1
public static final com.amx.duet.devicesdk.device.type.InputSourceSelect COMPOSITE10
public static final com.amx.duet.devicesdk.device.type.InputSourceSelect COMPOSITE2
public static final com.amx.duet.devicesdk.device.type.InputSourceSelect COMPOSITE3
public static final com.amx.duet.devicesdk.device.type.InputSourceSelect COMPOSITE4
public static final com.amx.duet.devicesdk.device.type.InputSourceSelect COMPOSITE5
public static final com.amx.duet.devicesdk.device.type.InputSourceSelect COMPOSITE6
public static final com.amx.duet.devicesdk.device.type.InputSourceSelect COMPOSITE7
public static final com.amx.duet.devicesdk.device.type.InputSourceSelect COMPOSITE8
public static final com.amx.duet.devicesdk.device.type.InputSourceSelect COMPOSITE9
public static final com.amx.duet.devicesdk.device.type.InputSourceSelect DVD
public static final com.amx.duet.devicesdk.device.type.InputSourceSelect FRONT_{—}1
public static final com.amx.duet.devicesdk.device.type.InputSourceSelect FRONT_2
public static final com.amx.duet.devicesdk.device.type.InputSourceSelect HDTV
public static final com.amx.duet.devicesdk.device.type.InputSourceSelect HD_COMPONENT1
public static final com.amx.duet.devicesdk.device.type.InputSourceSelect HD_COMPONENT10
public static final com.amx.duet.devicesdk.device.type.InputSourceSelect HD_COMPONENT2
public static final com.amx.duet.devicesdk.device.type.InputSourceSelect HD_COMPONENT3
public static final com.amx.duet.devicesdk.device.type.InputSourceSelect HD_COMPONENT4
public static final com.amx.duet.devicesdk.device.type.InputSourceSelect HD_COMPONENT5
public static final com.amx.duet.devicesdk.device.type.InputSourceSelect HD_COMPONENT6
public static final com.amx.duet.devicesdk.device.type.InputSourceSelect HD_COMPONENT7
public static final com.amx.duet.devicesdk.device.type.InputSourceSelect HD_COMPONENT8
public static final com.amx.duet.devicesdk.device.type.InputSourceSelect HD_COMPONENT9
public static final com.amx.duet.devicesdk.device.type.InputSourceSelect INVALID
public static final com.amx.duet.devicesdk.device.type.InputSourceSelect LASERDISC
public static final com.amx.duet.devicesdk.device.type.InputSourceSelect LINE_{—}1
public static final com.amx.duet.devicesdk.device.type.InputSourceSelect LINE_{—}2
public static final com.amx.duet.devicesdk.device.type.InputSourceSelect MEDIAPLAYER
public static final com.amx.duet.devicesdk.device.type.InputSourceSelect MINIDISC
public static final com.amx.duet.devicesdk.device.type.InputSourceSelect NONE
public static final com.amx.duet.devicesdk.device.type.InputSourceSelect PHONO
public static final com.amx.duet.devicesdk.device.type.InputSourceSelect RGB1
public static final com.amx.duet.devicesdk.device.type.InputSourceSelect RGB10
public static final com.amx.duet.devicesdk.device.type.InputSourceSelect RGB11
public static final com.amx.duet.devicesdk.device.type.InputSourceSelect RGB12
public static final com.amx.duet.devicesdk.device.type.InputSourceSelect RGB13
public static final com.amx.duet.devicesdk.device.type.InputSourceSelect RGB14
public static final com.amx.duet.devicesdk.device.type.InputSourceSelect RGB15
public static final com.amx.duet.devicesdk.device.type.InputSourceSelect RGB2
public static final com.amx.duet.devicesdk.device.type.InputSourceSelect RGB3
public static final com.amx.duet.devicesdk.device.type.InputSourceSelect RGB4
public static final com.amx.duet.devicesdk.device.type.InputSourceSelect RGB5
public static final com.amx.duet.devicesdk.device.type.InputSourceSelect RGB6
public static final com.amx.duet.devicesdk.device.type.InputSourceSelect RGB7
public static final com.amx.duet.devicesdk.device.type.InputSourceSelect RGB8
public static final com.amx.duet.devicesdk.device.type.InputSourceSelect RGB9
public static final com.amx.duet.devicesdk.device.type.InputSourceSelect SATELLITE
public static final com.amx.duet.devicesdk.device.type.InputSourceSelect SVIDEO1
public static final com.amx.duet.devicesdk.device.type.InputSourceSelect SVIDEO10
public static final com.amx.duet.devicesdk.device.type.InputSourceSelect SVIDEO11
public static final com.amx.duet.devicesdk.device.type.InputSourceSelect SVIDEO12
public static final com.amx.duet.devicesdk.device.type.InputSourceSelect SVIDEO13
public static final com.amx.duet.devicesdk.device.type.InputSourceSelect SVIDEO14
public static final com.amx.duet.devicesdk.device.type.InputSourceSelect SVIDEO15
public static final com.amx.duet.devicesdk.device.type.InputSourceSelect SVIDEO2
public static final com.amx.duet.devicesdk.device.type.InputSourceSelect SVIDEO3
public static final com.amx.duet.devicesdk.device.type.InputSourceSelect SVIDEO4
public static final com.amx.duet.devicesdk.device.type.InputSourceSelect SVIDEO5
public static final com.amx.duet.devicesdk.device.type.InputSourceSelect SVIDEO6
public static final com.amx.duet.devicesdk.device.type.InputSourceSelect SVIDEO7
public static final com.amx.duet.devicesdk.device.type.InputSourceSelect SVIDEO8
public static final com.amx.duet.devicesdk.device.type.InputSourceSelect SVIDEO9
public static final com.amx.duet.devicesdk.device.type.InputSourceSelect TAPE1
public static final com.amx.duet.devicesdk.device.type.InputSourceSelect TAPE2
public static final com.amx.duet.devicesdk.device.type.InputSourceSelect TUNER
public static final com.amx.duet.devicesdk.device.type.InputSourceSelect TV
public static final com.amx.duet.devicesdk.device.type.InputSourceSelect VCR
public static final com.amx.duet.devicesdk.device.type.InputSourceSelect VGA
public static final com.amx.duet.devicesdk.device.type.InputSourceSelect VIDEO1
public static final com.amx.duet.devicesdk.device.type.InputSourceSelect VIDEO10
public static final com.amx.duet.devicesdk.device.type.InputSourceSelect VIDEO2
public static final com.amx.duet.devicesdk.device.type.InputSourceSelect VIDEO3
public static final com.amx.duet.devicesdk.device.type.InputSourceSelect VIDEO4
public static final com.amx.duet.devicesdk.device.type.InputSourceSelect VIDEO5
public static final com.amx.duet.devicesdk.device.type.InputSourceSelect VIDEO6
public static final com.amx.duet.devicesdk.device.type.InputSourceSelect VIDEO7
public static final com.amx.duet.devicesdk.device.type.InputSourceSelect VIDEO8
public static final com.amx.duet.devicesdk.device.type.InputSourceSelect VIDEO9
public final boolean equals(java.lang.Object obj)
public final int hashCode( )
public java.lang.String toString( )
Class Keypad
public static final com.amx.duet.devicesdk.device.type.Keypad ALL_KEYPADS
public static final com.amx.duet.devicesdk.device.type.Keypad NO_KEYPAD
public Keypad(int keypadID)
public Keypad(java.lang.String keypadID)
public boolean equals(java.lang.Object obj)
public java.lang.String getKeypadID( )
public int hashCode( )
public java.lang.String toString( )
public static com.amx.duet.devicesdk.device.type.Keypad valueOf(com.amx.duet.devicesdk.device.type.Zone zone)
public static com.amx.duet.devicesdk.device.type.Keypad valueOf(int keypadID)
public static com.amx.duet.devicesdk.device.type.Keypad valueOf(java.lang.String keypadID)
public static final com.amx.duet.devicesdk.device.type.KeypadEvent BTN_DBL_PUSH
public static final com.amx.duet.devicesdk.device.type.KeypadEvent BTN_HOLD
public static final com.amx.duet.devicesdk.device.type.KeypadEvent BTN_PUSH
public static final com.amx.duet.devicesdk.device.type.KeypadEvent BTN_RELEASE
public static final com.amx.duet.devicesdk.device.type.KeypadEvent INVALID
public static final com.amx.duet.devicesdk.device.type.KeypadEvent LED_STATE_CHANGE
public final boolean equals(java.lang.Object obj)
public final int hashCode( )
public java.lang.String toString( )
Class KeypadEvent
public final Boolean equals(java.lang.Object obj)
public final int hashCode( )
public java.lang.String toString( )
Class KeypadNotification
public KeypadNotification(com.amx.duet.devicesdk.device.type.KeypadEvent ke, com.amx.duet.devicesdk.device.type.Controller ctrller, com.amx.duet.devicesdk.device.type.Keypad kp, com.amx.duet.devicesdk.device.type.ButtonAddress kb)
public boolean equals(java.lang.Object obj)
public com.amx.duet.devicesdk.device.type.Controller getController( )
public com.amx.duet.devicesdk.device.type.Keypad getKeypad( )
public com.amx.duet.devicesdk.device.type.ButtonAddress getKeypadButton( )
public com.amx.duet.devicesdk.device.type.KeypadEvent getKeypadEvent( )
public int hashCode( )
public java.lang.String toString( )
Class LampPowerState
public static final com.amx.duet.devicesdk.device.type.LampPowerState COOLING_DOWN
public static final com.amx.duet.devicesdk.device.type.LampPowerState INVALID
public static final com.amx.duet.devicesdk.device.type.LampPowerState WARMING_UP
Class LightAddress
public static final com.amx.duet.devicesdk.device.type.LightAddress ALL_LIGHTS
public static final com.amx.duet.devicesdk.device.type.LightAddress NO_LIGHTS
public LightAddress(int lightAddress)
public LightAddress(java.lang.String lightAddress)
public boolean equals(java.lang.Object obj)
public java.lang.String getLightLoadID( )
public int hashCode( )
public java.lang.String toString( )
public static com.amx.duet.devicesdk.device.type.LightAddress toValue(int lightAddress)
public static com.amx.duet.devicesdk.device.type.LightAddress toValue(java.lang.String lightAddress)
Class LightControllerNotification
public static final com.amx.duet.devicesdk.device.type.LightControllerNotification INVALID
public static final com.amx.duet.devicesdk.device.type.LightControllerNotification READY_FOR_NOTIFICATION_REQUESTS
public static final com.amx.duet.devicesdk.device.type.LightControllerNotification SECURITY_OFF
public static final com.amx.duet.devicesdk.device.type.LightControllerNotification SECURITY_ON
public static final com.amx.duet.devicesdk.device.type.LightControllerNotification VACATION_OFF
public static final com.amx.duet.devicesdk.device.type.LightControllerNotification VACATION_ON
public static final com.amx.duet.devicesdk.device.type.LightControllerNotification VACATION_RECORD
public final boolean equals(java.lang.Object obj)
public final int hashCode( )
public java.lang.String toString( )
Class LightNotification
public LightNotification(com.amx.duet.devicesdk.device.type.Controller ctrller, com.amx.duet.devicesdk.device.type.LightAddress 11, com.amx.duet.devicesdk.device.type.Zone zone, int percentage)
public boolean equals(java.lang.Object obj)
public com.amx.duet.devicesdk.device.type.Controller getController( )
public int getLightLevel( )
public com.amx.duet.devicesdk.device.type.LightAddress getLightLoad( )
public com.amx.duet.devicesdk.device.type.Zone getZone( )
public int hashCode( )
public java.lang.String toString( )
Class MediaCounter
public static final com.amx.duet.devicesdk.device.type.MediaCounter INVALID_COUNTER
public static final com.amx.duet.devicesdk.device.type.MediaCounter ZERO_COUNTER
public MediaCounter(com.amx.duet.devicesdk.device.type.MediaCounter tc)
public MediaCounter(int hrs int mins, int secs)
public MediaCounter(int hrs, int mins, int secs, int frame)
public boolean equals(java.lang.Object obj)
public int getFrame( )
public int getHours( )
public int getMinutes( )
public int getSeconds( )
public int hashCode( )
public java.lang.String toString( )
public static com.amx.duet.devicesdk.device.type.MediaCounter toValue(com.amx.duet.devicesdk.device.type.MediaCounter tc)
public static com.amx.duet.devicesdk.device.type.MediaCounter toValue(int hrs, int mins, int secs, int frame)
Class MediaDiscInfo
public MediaDiscInfo( )
Class MediaElement
public static final com.amx.duet.devicesdk.device.type.MediaElement ALBUM
public static final com.amx.duet.devicesdk.device.type.MediaElement ARTIST
public static final com.amx.duet.devicesdk.device.type.MediaElement GENRE
public static final com.amx.duet.devicesdk.device.type.MediaElement INVALID
public static final com.amx.duet.devicesdk.device.type.MediaElement PLAYLIST
public static final com.amx.duet.devicesdk.device.type.MediaElement TITLE
public static final com.amx.duet.devicesdk.device.type.MediaElement TRACK
public final boolean equals(java.lang.Object obj)
public final int hashCode( )
public java.lang.String toString( )
Class MediaRecord
public MediaRecord( )
public boolean queryMediaInfo( )
Class MediaSearchElement
public static final com.amx.duet.devicesdk.device.type.MediaSearchElement ALBUM_ID
public static final com.amx.duet.devicesdk.device.type.MediaSearchElement ALBUM_NAME
public static final com.amx.duet.devicesdk.device.type.MediaSearchElement ARTIST_ID
public static final com.amx.duet.devicesdk.device.type.MediaSearchElement ARTIST_NAME
public static final com.amx.duet.devicesdk.device.type.MediaSearchElement GENRE_ID
public static final com.amx.duet.devicesdk.device.type.MediaSearchElement GENRE_NAME
public static final com.amx.duet.devicesdk.device.type.MediaSearchElement INVALID
public static final com.amx.duet.devicesdk.device.type.MediaSearchElement PLAYLIST_ID
public static final com.amx.duet.devicesdk.device.type.MediaSearchElement PLAYLIST_NAME
public static final com.amx.duet.devicesdk.device.type.MediaSearchElement TITLE_ID
public static final com.amx.duet.devicesdk.device.type.MediaSearchElement TITLE_NAME
public static final com.amx.duet.devicesdk.device.type.MediaSearchElement TRACK_ID
public static final com.amx.duet.devicesdk.device.type.MediaSearchElement TRACK_NAME
public final boolean equals(java.lang.Object obj)
public final int hashCode( )
public java.lang.String toString( )
Class MediaSearchInfo
public MediaSearchInfo( )
public java.lang.String getSearchPath( )
Class MediaSearchRequest
public MediaSearchRequest( )
public static final com.amx.duet.devicesdk.device.type.MediaSide A
public static final com.amx.duet.devicesdk.device.type.MediaSide B
public static final com.amx.duet.devicesdk.device.type.MediaSide INVALID
public final boolean equals(java.lang.Object obj)
public final int hashCode( )
public java.lang.String toString( )
Class MediaSide
public final boolean equals(java.lang.Object obj)
public final int hashCode( )
public java.lang.String toString( )
Class MediaTitleInfo
public MediaTitleInfo( )
Class MediaTrackInfo
public MediaTrackInfo( )
public static final com.amx.duet.devicesdk.device.type.MotorDirection CLOSE
public static final com.amx.duet.devicesdk.device.type.MotorDirection INVALID
public static final com.amx.duet.devicesdk.device.type.MotorDirection OPEN
public static final com.amx.duet.devicesdk.device.type.MotorDirection STOP
public static final com.amx.duet.devicesdk.device.type.MotorDirection UNKNOWN
public final boolean equals(java.lang.Object obj)
public final int hashCode( )
public java.lang.String toString( )
Class MotorDirection
public final boolean equals(java.lang.Object obj)
public final int hashCode( )
public java.lang.String toString( )
Class MultiScreenSelect
public static final com.amx.duet.devicesdk.device.type.MultiScreenSelect INVALID
public static final com.amx.duet.devicesdk.device.type.MultiScreenSelect LEFT_SCREEN
public static final com.amx.duet.devicesdk.device.type.MultiScreenSelect MAIN_SCREEN
public static final com.amx.duet.devicesdk.device.type.MultiScreenSelect RIGHT_SCREEN
public static final com.amx.duet.devicesdk.device.type.MultiScreenSelect SUB_SCREEN
public final boolean equals(java.lang.Object obj)
public final int hashCode( )
public java.lang.String toString( )
Class Navigation
public static final com.amx.duet.devicesdk.device.type.Navigation DOWN
public static final com.amx.duet.devicesdk.device.type.Navigation DOWN_LEFT
public static final com.amx.duet.devicesdk.device.type.Navigation DOWN_RIGHT
public static final com.amx.duet.devicesdk.device.type.Navigation INVALID
public static final com.amx.duet.devicesdk.device.type.Navigation LEFT
public static final com.amx.duet.devicesdk.device.type.Navigation RIGHT
public static final com.amx.duet.devicesdk.device.type.Navigation UP
public static final com.amx.duet.devicesdk.device.type.Navigation UP_LEFT
public static final com.amx.duet.devicesdk.device.type.Navigation UP_RIGHT
public final boolean equals(java.lang.Object obj)
public final int hashCode( )
public java.lang.String toString( )
Class Password
public static final com.amx.duet.devicesdk.device.type.Password DEFAULT
public static final com.amx.duet.devicesdk.device.type.Password INVALID
public static final com.amx.duet.devicesdk.device.type.Password NO_PASSWORD
public static final com.amx.duet.devicesdk.device.type.Password OPTIONAL
public final boolean equals(java.lang.Object obj)
public java.lang.String getPassword( )
public final int hashCode( )
public void setPassword(byte[ ] password)
public void setPassword(char[ ] password)
public void setPassword(java.lang.String password)
public java.lang.String toString( )
Class PlayPositionInfo
public PlayPositionInfo( )
public PlayPositionInfo(com.amx.duet.devicesdk.device.type.MediaCounter discCounter, com.amx.duet.devicesdk.device.type.MediaCounter trackCounter, int trackNumber)
public PlayPositionInfo(com.amx.duet.devicesdk.device.type.PlayPositionInfo ppi)
public boolean equals(java.lang.Object obj)
public com.amx.duet.devicesdk.device.type.MediaCounter getDiscCounter( )
public com.amx.duet.devicesdk.device.type.MediaCounter getTrackCounter( )
public int getTrackNumber( )
public int hashCode( )
public void setDiscCounter(com.amx.duet.devicesdk.device.type.MediaCounter discCounter)
public void setTrackCounter(com.amx.duet.devicesdk.device.type.MediaCounter trackCounter)
public void setTrackNumber(int trackNumber)
public java.lang.String toString( )
Class PowerState
public static final com.amx.duet.devicesdk.device.type.PowerState INVALID
public static final com.amx.duet.devicesdk.device.type.PowerState OFF
public static final com.amx.duet.devicesdk.device.type.PowerState ON
public final boolean equals(java.lang.Object obj)
public final int hashCode( )
public java.lang.String toString( )
Class RampFocus
public static final com.amx.duet.devicesdk.device.type.RampFocus FAR
public static final com.amx.duet.devicesdk.device.type.RampFocus INVALID
public static final com.amx.duet.devicesdk.device.type.RampFocus NEAR
public static final com.amx.duet.devicesdk.device.type.RampFocus STOP
public static final com.amx.duet.devicesdk.device.type.RampFocus UNKNOWN
public final boolean equals(java.lang.Object obj)
public final int hashCode( )
public java.lang.String toString( )
Class RampIris
public static final com.amx.duet.devicesdk.device.type.RampIris CLOSE
public static final com.amx.duet.devicesdk.device.type.RampIris INVALID
public static final com.amx.duet.devicesdk.device.type.RampIris OPEN
public static final com.amx.duet.devicesdk.device.type.RampIris STOP
public static final com.amx.duet.devicesdk.device.type.RampIris UNKNOWN
public final boolean equals(java.lang.Object obj)
public final int hashCode( )
public java.lang.String toString( )
Class RampLevel
public static final com.amx.duet.devicesdk.device.type.RampLevel DOWN
public static final com.amx.duet.devicesdk.device.type.RampLevel INVALID
public static final com.amx.duet.devicesdk.device.type.RampLevel STOP
public static final com.amx.duet.devicesdk.device.type.RampLevel UP
public final boolean equals(java.lang.Object obj)
public final int hashCode( )
public java.lang.String toString( )
Class RampNotification
public RampNotification(com.amx.duet.devicesdk.device.type.Controller ctrller, com.amx.duet.devicesdk.device.type.LightAddress 11, com.amx.duet.devicesdk.device.type.Zone zone, com.amx.duet.devicesdk.device.type.RampLevel pos)
public boolean equals(java.lang.Object obj)
public com.amx.duet.devicesdk.device.type.Controller getController( )
public com.amx.duet.devicesdk.device.type.RampLevel getLevelAction( )
public com.amx.duet.devicesdk.device.type.LightAddress getLightLoad( )
public com.amx.duet.devicesdk.device.type.Zone getZone( )
public int hashCode( )
public java.lang.String toString( )
Class RampPan
public static final com.amx.duet.devicesdk.device.type.RampPan INVALID
public static final com.amx.duet.devicesdk.device.type.RampPan LEFT
public static final com.amx.duet.devicesdk.device.type.RampPan RIGHT
public static final com.amx.duet.devicesdk.device.type.RampPan STOP
public static final com.amx.duet.devicesdk.device.type.RampPan UNKNOWN
public final boolean equals(java.lang.Object obj)
public final int hashCode( )
public java.lang.String toString( )
Class RampTilt
public static final com.amx.duet.devicesdk.device.type.RampTilt DOWN
public static final com.amx.duet.devicesdk.device.type.RampTilt INVALID
public static final com.amx.duet.devicesdk.device.type.RampTilt STOP
public static final com.amx.duet.devicesdk.device.type.RampTilt UNKNOWN
public static final com.amx.duet.devicesdk.device.type.RampTilt UP
public final boolean equals(java.lang.Object obj)
public final int hashCode( )
public java.lang.String toString( )
Class RampZoom
public static final com.amx.duet.devicesdk.device.type.RampZoom IN
public static final com.amx.duet.devicesdk.device.type.RampZoom INVALID
public static final com.amx.duet.devicesdk.device.type.RampZoom OUT
public static final com.amx.duet.devicesdk.device.type.RampZoom STOP
public static final com.amx.duet.devicesdk.device.type.RampZoom UNKNOWN
public final boolean equals(java.lang.Object obj)
public final int hashCode( )
public java.lang.String toString( )
Class RandomState
public static final com.amx.duet.devicesdk.device.type.RandomState INVALID
public static final com.amx.duet.devicesdk.device.type.RandomState RANDOM_ALL
public static final com.amx.duet.devicesdk.device.type.RandomState RANDOM_DISC
public static final com.amx.duet.devicesdk.device.type.RandomState UNKNOWN
public final boolean equals(java.lang.Object obj)
public final int hashCode( )
public java.lang.String toString( )
Class RandomStateEx
public static final com.amx.duet.devicesdk.device.type.RandomStateEx PLAYLIST
Class Record
public Record( )
public java.lang.String getDisplayText( )
public java.lang.String getRecordID( )
public int getResultNumber( )
public java.lang.String getSearchHandle( )
public boolean queryImage( )
Class RepeatState
public static final com.amx.duet.devicesdk.device.type.RepeatState INVALID
public static final com.amx.duet.devicesdk.device.type.RepeatState REPEAT_ALL
public static final com.amx.duet.devicesdk.device.type.RepeatState REPEAT_DISC
public static final com.amx.duet.devicesdk.device.type.RepeatState REPEAT_TRACK
public static final com.amx.duet.devicesdk.device.type.RepeatState UNKNOWN
public final boolean equals(java.lang.Object obj)
public final int hashCode( )
public java.lang.String toString( )
Class RepeatStateEx
public static final com.amx.duet.devicesdk.device.type.RepeatStateEx PLAYLIST
public static final com.amx.duet.devicesdk.device.type.ScanSpeed EIGHT
public static final com.amx.duet.devicesdk.device.type.ScanSpeed FOUR
public static final com.amx.duet.devicesdk.device.type.ScanSpeed INVALID
public static final com.amx.duet.devicesdk.device.type.ScanSpeed ONE
public static final com.amx.duet.devicesdk.device.type.ScanSpeed ONE_EIGHTH
public static final com.amx.duet.devicesdk.device.type.ScanSpeed ONE_FOURTH
public static final com.amx.duet.devicesdk.device.type.ScanSpeed ONE_HALF
public static final com.amx.duet.devicesdk.device.type.ScanSpeed SIXTEEN
public static final com.amx.duet.devicesdk.device.type.ScanSpeed THIRTY_TWO
public static final com.amx.duet.devicesdk.device.type.ScanSpeed TWO
public static final com.amx.duet.devicesdk.device.type.ScanSpeed ZERO
public final boolean equals(java.lang.Object obj)
public final int hashCode( )
public java.lang.String toString( )
Class ScanSpeed
public final boolean equals(java.lang.Object obj)
public final int hashCode( )
public java.lang.String toString( )
Class Scope
public static final com.amx.duet.devicesdk.device.type.Scope GLOBAL
public static final com.amx.duet.devicesdk.device.type.Scope INVALID
public static final com.amx.duet.devicesdk.device.type.Scope LOCAL
public static final com.amx.duet.devicesdk.device.type.Scope UNKNOWN
public final boolean equals(java.lang.Object obj)
public final int hashCode( )
public java.lang.String toString( )
Class SearchInfo
public SearchInfo( )
public SearchInfo(com.amx.duet.devicesdk.device.type.MediaElement searchField, java.lang.String criteria, java.lang.String result, com.amx.duet.devicesdk.device.type.DiscInfo discInfo)
public SearchInfo(com.amx.duet.devicesdk.device.type.SearchInfo searchInfo)
public void absolute(int position)
public void afterLast( )
public void beforeFirst( )
public void close( )
public boolean equals(java.lang.Object obj)
public void first( )
public com.amx.duet.devicesdk.device.type.DiscInfo getDiscInfo( )
public java.lang.String getSearchCriteria( )
public com.amx.duet.devicesdk.device.type.MediaElement getSearchField( )
public java.lang.String getSearchResult( )
public boolean hasNext( )
public boolean hasPrevious( )
public int hashCode( )
public void last( )
public boolean queryNext( )
public boolean queryNext(int quantity)
public boolean queryPrevious( )
public boolean queryPrevious(int quantity)
public void relative(int position)
public void setDiscInfo(com.amx.duet.devicesdk.device.type.DiscInfo discInfo)
public void setSearchCriteria(java.lang.String criteria)
public void setSearchField(com.amx.duet.devicesdk.device.type.MediaElement searchField)
public void setSearchResult(java.lang.String result)
public java.lang.String toString( )
Class SearchRequest
public SearchRequest( )
public static final com.amx.duet.devicesdk.device.type.SearchSpeed EIGHT
public static final com.amx.duet.devicesdk.device.type.SearchSpeed FOUR
public static final com.amx.duet.devicesdk.device.type.SearchSpeed INVALID
public static final com.amx.duet.devicesdk.device.type.SearchSpeed ONE
public static final com.amx.duet.devicesdk.device.type.SearchSpeed ONE_EIGHTH
public static final com.amx.duet.devicesdk.device.type.SearchSpeed ONE_FOURTH
public static final com.amx.duet.devicesdk.device.type.SearchSpeed ONE_HALF
public static final com.amx.duet.devicesdk.device.type.SearchSpeed SIXTEEN
public static final com.amx.duet.devicesdk.device.type.SearchSpeed THIRTY_TWO
public static final com.amx.duet.devicesdk.device.type.SearchSpeed TWO
public static final com.amx.duet.devicesdk.device.type.SearchSpeed ZERO
public final boolean equals(java.lang.Object obj)
public final int hashCode( )
public java.lang.String toString( )
Class SearchSpeed
public final boolean equals(java.lang.Object obj)
public final int hashCode( )
public java.lang.String toString( )
Class SecurityButton
public static final com.amx.duet.devicesdk.device.type.SecurityButton ARM
public static final com.amx.duet.devicesdk.device.type.SecurityButton ARM_HOME
public static final com.amx.duet.devicesdk.device.type.SecurityButton ARM_HOME_NOW
public static final com.amx.duet.devicesdk.device.type.SecurityButton ARM_NOW
public static final com.amx.duet.devicesdk.device.type.SecurityButton BYPASS
public static final com.amx.duet.devicesdk.device.type.SecurityButton CANCEL_BYPASS
public static final com.amx.duet.devicesdk.device.type.SecurityButton DISARM
public static final com.amx.duet.devicesdk.device.type.SecurityButton FIRE
public static final com.amx.duet.devicesdk.device.type.SecurityButton MEDICAL
public static final com.amx.duet.devicesdk.device.type.SecurityButton PANIC
public static final com.amx.duet.devicesdk.device.type.SecurityButton POLICE
Class SecurityPartition
public static final com.amx.duet.devicesdk.device.type.SecurityPartition ALL_SECURITY_PARTITIONS
public static final int UNUSED_FIELD
public SecurityPartition( )
public SecurityPartition(int partition)
public boolean equals(java.lang.Object obj)
public int getPartition( )
public int hashCode( )
public void setPartition(int partition)
public java.lang.String toString( )
Class SecurityPoint
public static final com.amx.duet.devicesdk.device.type.SecurityPoint ALL_SECURITY_POINTS
public static final int UNUSED_FIELD
public SecurityPoint( )
public SecurityPoint(int point)
public boolean equals(java.lang.Object obj)
public int getPoint( )
public int hashCode( )
public void setPoint(int point)
public java.lang.String toString( )
Class SecurityPointState
public static final com.amx.duet.devicesdk.device.type.SecurityPointState ACTIVE
public static final com.amx.duet.devicesdk.device.type.SecurityPointState BYPASS
public static final com.amx.duet.devicesdk.device.type.SecurityPointState INVALID
public final boolean equals(java.lang.Object obj)
public final int hashCode( )
public java.lang.String toString( )
Class SecurityPointStatus
public static final com.amx.duet.devicesdk.device.type.SecurityPointStatus ACTIVE
public static final com.amx.duet.devicesdk.device.type.SecurityPointStatus BYPASSED
public static final com.amx.duet.devicesdk.device.type.SecurityPointStatus FAULT
public static final com.amx.duet.devicesdk.device.type.SecurityPointStatus INVALID
public final boolean equals(java.lang.Object obj)
public final int hashCode( )
public java.lang.String toString( )
Class SecurityState
public static final com.amx.duet.devicesdk.device.type.SecurityState ARM
public static final com.amx.duet.devicesdk.device.type.SecurityState ARM_HOME
public static final com.amx.duet.devicesdk.device.type.SecurityState ARM_HOME_NOW
public static final com.amx.duet.devicesdk.device.type.SecurityState ARM_NOW
public static final com.amx.duet.devicesdk.device.type.SecurityState DISARM
public static final com.amx.duet.devicesdk.device.type.SecurityState FIRE
public static final com.amx.duet.devicesdk.device.type.SecurityState INVALID
public static final com.amx.duet.devicesdk.device.type.SecurityState MEDICAL
public static final com.amx.duet.devicesdk.device.type.SecurityState NONE
public static final com.amx.duet.devicesdk.device.type.SecurityState PANIC
public static final com.amx.duet.devicesdk.device.type.SecurityState POLICE
public final boolean equals(java.lang.Object obj)
public final int hashCode( )
public java.lang.String toString( )
Class SecurityStatus
public static final com.amx.duet.devicesdk.device.type.SecurityStatus ALARM
public static final com.amx.duet.devicesdk.device.type.SecurityStatus ARMED
public static final com.amx.duet.devicesdk.device.type.SecurityStatus ARMED_HOME
public static final com.amx.duet.devicesdk.device.type.SecurityStatus DISARMED
public static final com.amx.duet.devicesdk.device.type.SecurityStatus INVALID
public final boolean equals(java.lang.Object obj)
public final int hashCode( )
public java.lang.String toString( )
Class SpeedDialEntry
public SpeedDialEntry( )
public SpeedDialEntry(java.lang.String label, java.lang.String number)
public boolean equals(java.lang.Object obj)
public java.lang.String getLabel( )
public java.lang.String getNumber( )
public int hashCode( )
public void setLabel(java.lang.String label)
public void setNumber(java.lang.String number)
public java.lang.String toString( )
Class StationSearchCommand
public static final com.amx.duet.devicesdk.device.type.StationSearchCommand BACKWARD
public static final com.amx.duet.devicesdk.device.type.StationSearchCommand FORWARD
public static final com.amx.duet.devicesdk.device.type.StationSearchCommand INVALID
public static final com.amx.duet.devicesdk.device.type.StationSearchCommand STOP
public final boolean equals(java.lang.Object obj)
public final int hashCode( )
public java.lang.String toString( )
Class SurroundState
public static final com.amx.duet.devicesdk.device.type.SurroundState GAME
public static final com.amx.duet.devicesdk.device.type.SurroundState HEADPHONE
public static final com.amx.duet.devicesdk.device.type.SurroundState INVALID
public static final com.amx.duet.devicesdk.device.type.SurroundState MOVIE
public static final com.amx.duet.devicesdk.device.type.SurroundState MUSIC
public static final com.amx.duet.devicesdk.device.type.SurroundState OFF
public static final com.amx.duet.devicesdk.device.type.SurroundState SIX_CH_STEREO
public static final com.amx.duet.devicesdk.device.type.SurroundState SPORTS
public static final com.amx.duet.devicesdk.device.type.SurroundState TV
public static final com.amx.duet.devicesdk.device.type.SurroundState TWO_CH_STEREO
public final boolean equals(java.lang.Object obj)
public final int hashCode( )
public java.lang.String toString( )
Class SwitchLevel
public static final com.amx.duet.devicesdk.device.type.SwitchLevel ALL
public static final com.amx.duet.devicesdk.device.type.SwitchLevel AUDIO
public static final com.amx.duet.devicesdk.device.type.SwitchLevel INVALID
public static final com.amx.duet.devicesdk.device.type.SwitchLevel NONE
public static final com.amx.duet.devicesdk.device.type.SwitchLevel VIDEO
public final boolean equals(java.lang.Object obj)
public final int hashCode( )
public java.lang.String toString( )
Class TapeRecordSpeed
public static final com.amx.duet.devicesdk.device.type.TapeRecordSpeed EP
public static final com.amx.duet.devicesdk.device.type.TapeRecordSpeed INVALID
public static final com.amx.duet.devicesdk.device.type.TapeRecordSpeed LP
public static final com.amx.duet.devicesdk.device.type.TapeRecordSpeed SP
public final boolean equals(java.lang.Object obj)
public final int hashCode( )
public java.lang.String toString( )
Class TapeTransport
public static final com.amx.duet.devicesdk.device.type.TapeTransport FF
public static final com.amx.duet.devicesdk.device.type.TapeTransport INVALID
public static final com.amx.duet.devicesdk.device.type.TapeTransport PAUSE
public static final com.amx.duet.devicesdk.device.type.TapeTransport PLAY
public static final com.amx.duet.devicesdk.device.type.TapeTransport RECORD
public static final com.amx.duet.devicesdk.device.type.TapeTransport RECORD_PAUSE
public static final com.amx.duet.devicesdk.device.type.TapeTransport REW
public static final com.amx.duet.devicesdk.device.type.TapeTransport SEARCH_FWD
public static final com.amx.duet.devicesdk.device.type.TapeTransport SEARCH_REV
public static final com.amx.duet.devicesdk.device.type.TapeTransport STOP
public static final com.amx.duet.devicesdk.device.type.TapeTransport UNKNOWN
public final boolean equals(java.lang.Object obj)
public final int hashCode( )
public java.lang.String toString( )
Class TemperatureScale
public static final com.amx.duet.devicesdk.device.type.TemperatureScale CELSIUS
public static final com.amx.duet.devicesdk.device.type.TemperatureScale FAHRENHEIT
public static final com.amx.duet.devicesdk.device.type.TemperatureScale INVALID
public static float convertCelsiusToFahrenheit(float degreeCelsius)
public static float convertFahrenbeitToCelsius(float degreeFahrenheit)
public final boolean equals(java.lang.Object obj)
public final int hashCode( )
public java.lang.String toString( )
Class Time
public static final com.amx.duet.devicesdk.device.type.Time INVALID_TIME
public static final com.amx.duet.devicesdk.device.type.Time ZERO_TIME
public Time(com.amx.duet.devicesdk.device.type.Time time)
public Time(int hrs int mins, int secs)
public boolean equals(java.lang.Object obj)
public int getHours( )
public int getMinutes( )
public int getSeconds( )
public int hashCode( )
public java.lang.String toString( )
public static com.amx.duet.devicesdk.device.type.Time toValue(com.amx.duet.devicesdk.device.type.Time time)
public static com.amx.duet.devicesdk.device.type.Time toValue(int hrs, int mins. int secs)
Class TitleInfo
public TitleInfo( )
public TitleInfo(com.amx.duet.devicesdk.device.type.TitleInfo ti)
public TitleInfo(int discSlotNumber, int titleNumber, int totalTracks)
public boolean equals(java.lang.Object obj)
public int getDiscSlotNumber( )
public int getTitleNumber( )
public int getTotalTracks( )
public int hashCode( )
public void setDiscSlotNumber(int discSlotNumber)
public void setTitleNumber(int titleNumber)
public void setTotalTracks(int totalTracks)
public java.lang.String toString( )
Class TrackInfo
public TrackInfo( )
public TrackInfo(com.amx.duet.devicesdk.device.type.TrackInfo ti)
public TrackInfo(int discSlotNumber, int trackNumber, com.amx.duet.devicesdk.device.type.Time duration)
public boolean equals(java.lang.Object obj)
public int getDiscSlotNumber( )
public com.amx.duet.devicesdk.device.type.Time getDuration( )
public int getTrackNumber( )
public int hashCode( )
public void setDiscSlotNumber(int discSlotNumber)
public void setDuration(com.amx.duet.devicesdk.device.type.Time duration)
public void setTrackNumber(int trackNumber)
public java.lang.String toString( )
Class TunerBand
public static final com.amx.duet.devicesdk.device.type.TunerBand AM
public static final com.amx.duet.devicesdk.device.type.TunerBand FM
public static final com.amx.duet.devicesdk.device.type.TunerBand INVALID
public static final com.amx.duet.devicesdk.device.type.TunerBand LONG_WAVE
public static final com.amx.duet.devicesdk.device.type.TunerBand MEDIUM_WAVE
public static final com.amx.duet.devicesdk.device.type.TunerBand SATELLITE_RADIO
public static final com.amx.duet.devicesdk.device.type.TunerBand SHORT_WAVE
public static final com.amx.duet.devicesdk.device.type.TunerBand TV
public final boolean equals(java.lang.Object obj)
public final int hashCode( )
public java.lang.String toString( )
Class VideoState
public static final com.amx.duet.devicesdk.device.type.VideoState INVALID
public static final com.amx.duet.devicesdk.device.type.VideoState NTSC
public static final com.amx.duet.devicesdk.device.type.VideoState PAL
public static final com.amx.duet.devicesdk.device.type.VideoState SECAM
public static final com.amx.duet.devicesdk.device.type.VideoState UNKNOWN
public final boolean equals(java.lang.Object obj)
public final int hashCode( )
public java.lang.String toString( )
Class Zone
public static final com.amx.duet.devicesdk.device.type.Zone ALL_ZONES
public static final com.amx.duet.devicesdk.device.type.Zone NO_ZONE
public static final int UNUSED_FIELD
public Zone( )
public Zone(int zone)
public boolean equals(java.lang.Object obj)
public int getZone( )
public int hashCode( )
public void setZone(int zone)
public java.lang.String toString( )
public static com.amx.duet.devicesdk.device.type.Zone toValue(int zone)

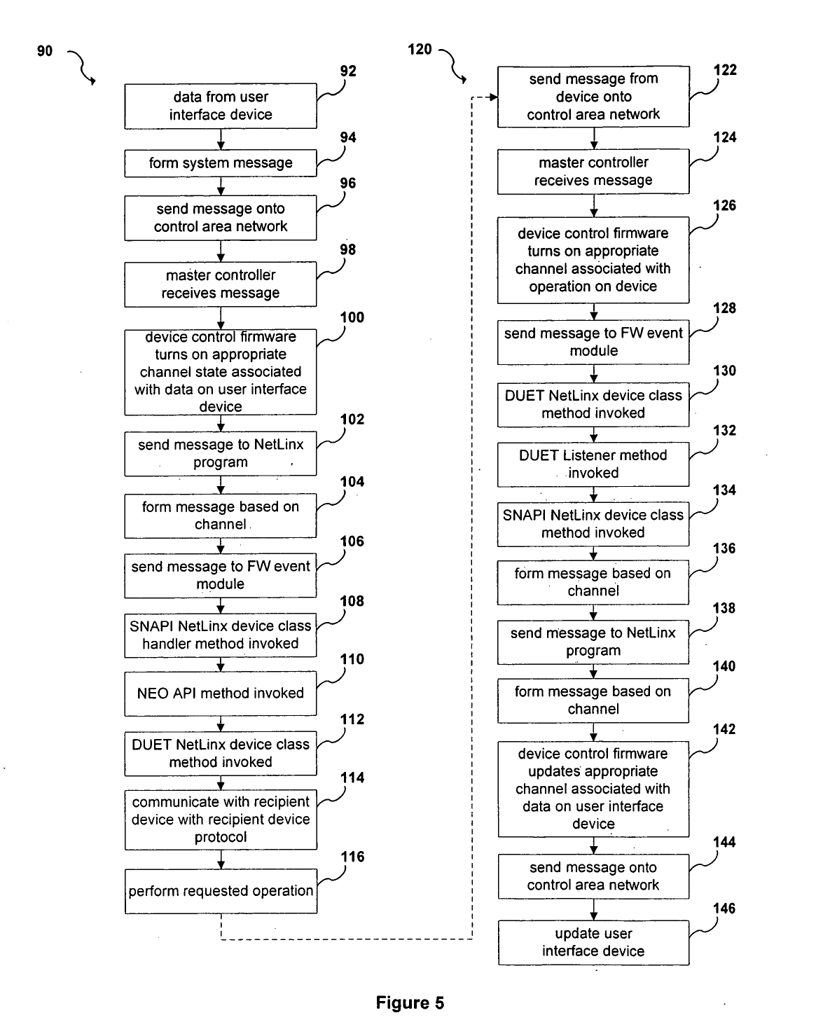

Referring to FIG. 5, a flow chart illustrating command processing using a standard interface device controller according to an embodiment of the present invention is shown. As shown at block 92, data is generated from a user interface device 14 that will be communicated to one or more devices 16a-16n. Data may be generated from the user interface device 14 by the user entering an alphanumeric string, clicking on a button icon on a graphical user interface, pushing a button on a touch panel, or other suitable input. The user interface device 14 then forms a control system message including, but not limited to, a channel associated with the data and the sender of the message, as shown at block 94. Each of the one or more devices 16a-16n, both sender and recipient devices, are uniquely identified by a DPS (device:port:system) value. A channel is a number uniquely identifying each addressable operation, component or graphical element of each device 14 and 16a-16n. For instance, each button icon on a graphical user interface of the user interface device 14 is assigned a unique channel number. Further, the play, stop and rewind operation on a VCR device 16a-16n are each assigned unique channel numbers. The message is then sent onto the control area network, as shown at block 96. As shown at block 98, the master controller 40 on that network receives the message via one or more control ports 54. Control ports 54 includes, but is not limited to, Infrared (IR) ports, serial ports, relays and digital I/O.

A channel state associated with the origin of the data (e.g., a particular button pressed on user interface device 14) is turned ON by the device control FW 44 to indicate that the channel is on, as shown at block 100. A message incorporating the channel number and the sender of the message is then sent to a NetLinx program 48a executed by a NetLinx interpreter 42, as shown at block 102. As shown at block 104, the NetLinx program 48a determines the appropriate action based on the channel number and, based on that action, forms a message including the appropriate recipient and a channel number uniquely identifying an operation on the recipient device 16a-16n. The message is sent via device control firmware 44 to FW event module 80 within the Java virtual machine 60, as shown at block 106. As shown at block 108, based on the recipient and channel number, an appropriate event handler method is invoked within a NetLinx device class 64 of the SNAPI object 62. The event handler method invokes one or more DUET API 78 standard API methods that correspond to one or more operations on the recipient device 16a-16n, as shown at block 110. An appropriate method within a DUET NetLinx device class 68 is then invoked by the DUET API 78, as shown at block 112. The DUET NetLinx device class 68 method then communicates the requested operation to the recipient device 16a-16n using the recipient's device protocol, as shown at block 114. As shown at block 116, the requested operation is thereby performed on the recipient device 16a-16n.

Depending on the recipient device 16a-16n and the requested operation, the recipient device 16a-16n may or may not send a response message onto the control area network. If the recipient device 16a-16n does send a response message, then the response message is sent onto the control area network as shown at block 122. As shown at block 124, the master controller 40 on that network receives the message via one or more control ports 54, and then processes the message. A channel associated with the operation on the device 16a-16n is turned ON by the device control FW 44, as shown at block 126. A message incorporating the channel number and the sender of the message is then sent via device control firmware 44 to FW event module 80 within the Java virtual machine 60, as shown at block 128.

As shown at block 130, based on the sender and channel number, an appropriate event handler method is invoked within a NetLinx device class 68 of the DUET object 66. The event handler method invokes one or more DUET feedback API 76 standard API methods that correspond to one or more operations in the SNAPI router 62, as shown at block 132. An appropriate method within the SNAPI NetLinx device class 64 is then invoked by the DUET API 78, as shown at block 134. As shown at block 136, the SNAPI NetLinx device class 64 method then determines the appropriate recipient based on the channel number and forms a message including the appropriate recipient and a channel number uniquely identifying a SNAPI router notification 82. The message is sent via device control firmware 44 to the NetLinx program 48a executed by a NetLinx interpreter 42, as shown at block 138.

As shown at block 140, the NetLinx program 48a determines the appropriate action based on the channel number and, based on that action, forms a message including the appropriate recipient and a channel number uniquely identifying a component on user interface 14. The message is sent via device control firmware 44 to user interface device 14, as shown at block 144. A channel associated with the origin of the data (e.g., a particular button pressed on user interface device 14) is updated by the device control FW, as shown at block 142. The ON state of the channel of the origin of the data (e.g., a particular button pressed on user interface device 14) is conveyed to the user interface device 14, such that the user interface device 14 may provide feedback to the user. For instance, highlighting a particular button, as shown at block 146.

For example, referring to FIGS. 1, 2 and 5, as shown at block 92, a user may have selected a “play” button on a touch panel of a user interface device 14 that corresponds to a particular VCR 16a. Assuming that the “play” button is identified as channel “40” and the user interface device 14 is identified as sender “128:1:1,” a message will be formed containing at least the sender, channel pair (e.g., the message contains at least “128:1:1” and “40”). The user interface device 14 may send the message to the master controller 40 via a serial control port 54 on the master controller 40. A channel state (“40”) associated with the “play” button on user interface device 14 is turned ON by the master controller to indicate that the channel is on, as shown at block 100. A message incorporating the channel number, the sender of the message, and the recipient of the message is then sent to a NetLinx program 48a executed by a NetLinx interpreter 42, as shown at block 102.

As shown at block 104, the NetLinx program 48a determines the particular VCR device 16a based on the channel number of the “play” button of the user interface 14 and forms a message including the VCR 16a and a channel number uniquely identifying an operation on the VCR 16a. Assuming that the “play” operation on the VCR is identified as channel “60” and the SNAPI NetLinx device class 64 representing VCR 16a is identified as recipient “4000:1:1,” a message will be formed containing at least the recipient, channel pair (e.g., the message contains at least “4000:1:1” and “60”).

The message is sent via device control firmware 44 to FW event module 80 within the Java virtual machine 60, as shown at block 106. As shown at block 108, based on the recipient and channel number, a channel event handler method is invoked within a NetLinx device class 64 of the SNAPI object 62. The event handler method invokes the play( ) method of the DUET API 78 standard API that correspond to the play operation on the VCR 16a, as shown at block 110. The sendString( ) method within the DUET NetLinx device class 68 is then invoked by the DUET API 78, as shown at block 112. The DUET NetLinx device class 68 method then communicates the requested operation to the VCR 16a using the VCR's proprietary protocol, as shown at block 114. As shown at block 116, the play operation is thereby performed on the VCR 16a.

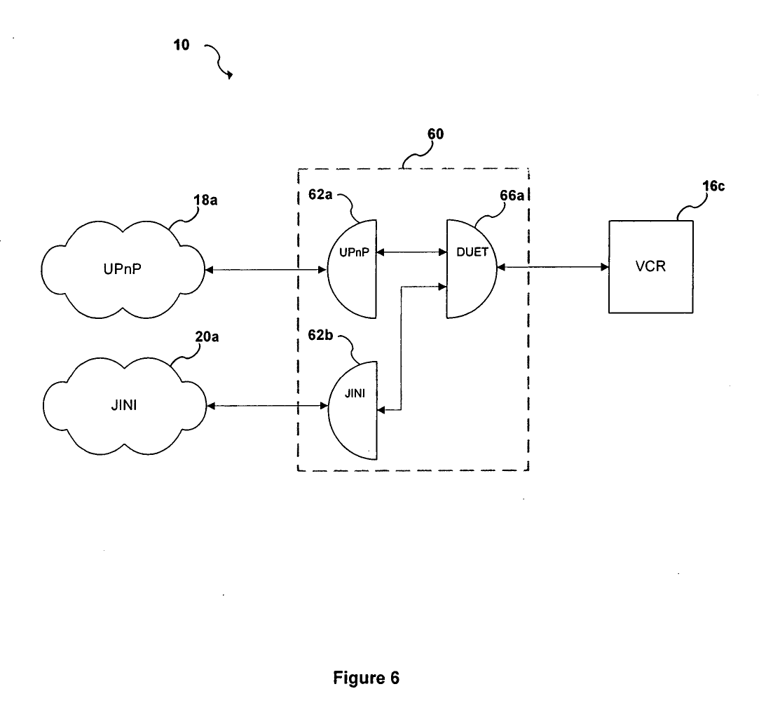

Referring to FIG. 6, a block diagram illustrating a control system configuration interconnecting two disparate protocols according to an embodiment of the present invention is shown. In this configuration, one or more devices in a UPnP network 18a communicate with a UPnP router 62a having similar functionality as the SNAPI object 62 previously described. Further, one or more devices in a JINI network 20a communicate with a JINI router 62b also having similar functionality as the SNAPI object 62 previously described. Devices on the UPnP network 18a are interconnected to devices on the JINI network 20a via DUET object 66. Additionally, devices 16a-16n, such as VCR 16c, on a control area network 12 may communicate with one or more devices on either the UPnP network 18a or the JINI network 20a.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise than as specifically described.

1. A method for controlling devices in a control area network, comprising:
providing a first application programming interface containing a first set of functions in a control area network, wherein the control area network comprises a master controller, one or more physical devices, and one or more physical device communication interfaces; and
associating one or more functions of the first set of functions with a physical device, wherein each physical device is associated using one or more of the physical device communication interfaces.

2. The method of claim 1, wherein at least one of the physical device communication interfaces is different from at least another of the physical device communication interfaces.

3. The method of claim 2, wherein at least one function of the first set of functions is associated to at least two physical devices having different physical device communication interfaces.

4. The method of claim 3, wherein the first set of functions comprises a standard interface with one or more of the physical device communication interfaces.

5. The method of claim 4, wherein the first set of functions comprises an object-oriented standard interface.

6. The method of claim 4, wherein the standard interface is used to control one or more of the physical devices.

7. The method of claim 4, wherein the control area network further comprise one or more NetLinx control programs in communication with the first set of functions.

8. The method of claim 6, wherein one or more of the physical devices are in communication with at least one NetLinx control program.

9. The method of claim 3, wherein the control area network further comprises one or more virtual devices and an application, the method further comprising:
providing a second application programming interface containing a second set of functions in a control area network, wherein the second application programming interface is configured to be used by the application;
associating one or more functions of the second set of functions with each virtual device; and
associating each virtual device with one or more physical devices, wherein each virtual device is coupled associated using one or more functions of the first set of functions.

10. The method of claim 4, wherein at least one of the virtual devices is associated to two or more of the physical devices.

11. The method of claim 5, wherein each physical device includes a set of attributes, the control area network further comprises a plurality of physical device classes, and each physical device class comprises one or more of the physical devices having at least one common attribute.

12. A computer program for controlling devices in a control area network, the computer program comprising:
a first computer code for providing a first application programming interface containing a first set of functions in a control area network, wherein the control area network comprises a master controller, one or more physical devices, and one or more physical communication interfaces; and
a second computer code for associating one or more functions of the first set of functions with a physical device, wherein each physical device is coupled associated using one or more of the physical device communication interfaces.

13. A computer system for controlling devices in a control area network, comprising:
one or more processors; and
a computer readable medium connected to the processors, the computer readable medium including processor instructions configured to be read by the processors and thereby cause the processors to:
provide a first application programming interface containing a first set of functions in a control area network, wherein the control area network comprises a master controller, one or more physical devices, and one or more physical communication interfaces; and
associate one or more functions of the first set of functions with a physical device, wherein each physical device is associated using one or more of the physical device communication interfaces.

14. A method for controlling devices in a control area network, comprising:
providing one or more application programming interfaces, wherein each application programming interface corresponds to a class of devices and comprises a set of functions, each class of devices includes one or more devices; and
associating one or more of the functions of at least one of the application programming interfaces with one or more of the devices.

15. The method of claim 14, wherein one or more of the devices comprise physical devices, and the physical devices of each class of devices have at least one of a common operation and a common functionality.

16. The method of claim 15, wherein one or more of the physical devices utilize proprietary protocols.

17. The method of claim 16, further comprising abstracting the proprietary protocols of the physical devices from application programming interfaces using the respective associated functions.

18. The method of claim 17, further comprising operating a selected one of the physical devices using the associated functions.

19. The method of claim 15, wherein the control area network includes a master controller.

20. The method of claim 15, wherein each of the application programming interfaces comprises an object-oriented application programming interface.

21. The method of claim 15, further comprising the physical devices communicating with respective application programming interfaces using one or more event handlers.

22. The method of claim 15, wherein at least one of the physical devices is different from one or more of the other physical devices.

23. The method of claim 14, wherein at least one class of devices comprises a plurality of subclasses, and each subclass includes one or more physical devices.

24. The method of claim 23, wherein the physical devices of each subclass have at least one of a common operation and a common functionality.

25. The method of claim 15, wherein at least one class of devices comprises one or more brands of home entertainment devices.

26. The method of claim 25, wherein the home entertainment devices comprise at least one of A/V receivers, monitors, video projectors, televisions, digital satellite systems (DSS), set top boxes, disk devices, DVR/PVRs, digital media players, DVD players, VCRs, DVRs, VCR/DVD combination players, video conferencers, audio tuners, cassette decks, level controllers, pre-amplifiers, audio processors, cameras, lights, cable receivers, and satellite receivers.

27. The method of claim 15, wherein at least one class of devices comprises one or more brands of security equipment.

28. The method of claim 15, wherein the security equipment comprise at least one of cameras, sensors, alarms and motion detectors.

29. The method of claim 15, wherein at least one class of devices comprises one or more brands of environmental control equipment.

30. The method of claim 29, wherein the environmental control equipment comprise at least one of heating units and air conditioning units.

31. The method of claim 15, wherein at least one class of devices comprises one or more brands of household appliances.

32. The method of claim 18, wherein the operation is initiated from a second control area network.

33. The method of claim 32, wherein the control area network and the second control area network have disparate protocols.

34. The method of claim 33, wherein the disparate protocols comprise at least one of AMX NetLinx, Microsoft universal plug and play (UPnP), and Sun Microsystems JINI.

35. The method of claim 14, wherein one or more of the devices comprise virtual devices, and the virtual devices of each class of devices have at least one of a common operation and a common functionality.

36. The method of claim 35, wherein each virtual device comprises a plurality of physical devices.

37. The method of claim 36, wherein at least one virtual device comprises a home entertainment system.

38. The method of claim 37, wherein the home entertainment system comprise at least one of A/V receivers, monitors, video projectors, televisions, digital satellite systems (DSS), set top boxes, disk devices, DVR/PVRs, digital media players, DVD players, VCRs, DVRs, VCRIDVD combination players, video conferencers, audio tuners, cassette decks, level controllers, pre-amplifiers, audio processors, cameras, lights, cable receivers, and satellite receivers.

39. The method of claim 14, wherein one or more of the devices comprise logical devices.

40. The method of claim 39, wherein at least one logical device comprises a control system.

41. The method of claim 19, further comprising the master controller periodically polling one or more of the devices.

42. The method of claim 41, further comprising returning device information to the master control from each of the polled devices.

43. The method of claim 42, wherein the device information comprises a device status.

44. The method of claim 42, wherein the device information comprises identification of a new device.
